(19) United States
(12) Patent Application Publication
(10) Pub. No.: US 2019/0019331 A1
(43) Pub. Date: Jan. 17, 2019

(54) PROCESSING OF GEOMETRIC DATA WITH ISOTOPIC APPROXIMATION WITHIN A TOLERANCE VOLUME

(71) Applicant: INRIA INSTITUT NATIONAL DE RECHERCHE EN INFORMATIQ, Le Chesnay (FR)

(72) Inventors: Pierre ALLIEZ, Valbonne (FR); David COHEN-STEINER, Mougins (FR); Manish MANDAD, Nice (FR)

(21) Appl. No.: 15/749,011

(22) PCT Filed: Aug. 1, 2016
(86) PCT No.: PCT/FR2016/051997

§ 371 Date: Sep. 27, 2018

(30) Foreign Application Priority Data
Aug. 1, 2015 (FR) 1501664
Aug. 11, 2015 (FR) 1557674

(51) Int. Cl. G06T 17/10; G06T 17/20; G06F 17/17; G06T 15/00

(52) U.S. Cl. CPC G06T 17/10; G06T 17/205; G06F 17/17; G06T 2219/004; G06T 2210/56; G06T 2219/012; G06T 15/005

(57) ABSTRACT

The processing of geometric data starts with a tolerance volume Ω that is related to raw geometric starting data. A canonical triangulation is initiated (201) in the tolerance volume, on the basis of a set S of sample points taken at the limits of this tolerance volume, and points LBB located on the exterior thereof. This canonical triangulation is refined (203) until the sample points have been classified, thereby obtaining a dense mesh of the tolerance volume. This dense mesh is then simplified (207) via triangulation modification operations, while preserving the topology and classification of the sample points.

The invention relates to the data processing techniques for construction or reconstruction of geometrical surfaces.

Basically, a surface or a shape may be represented by a set of points in space which is then referred to as a “point cloud”.

In order to allow its computer processing as a surface, a two-dimensional surface is often represented by a mesh based on elemental triangles. Similarly, a three-dimensional volume may be represented in data processing by a tetrahedral mesh. The expressions “triangular mesh” and triangulation cover all of these cases.

A representation of surfaces by “triangular mesh” or parametric surfaces may be imperfect, most often due to the limitations of the sensors used to establish it and of the algorithms for reconstruction of surfaces based on the measurements. The defects may for example be holes, or else self-intersections (since it is rare for a real world surface to cross itself). The expression “triangle soup” is used for a triangulation which may be imperfect.

Obtaining a correct approximation of complex shapes with triangular mesh elements (also referred to as “simplicial”) is a multi-facetted problem involving the geometry, the topology, and their discretization (dividing up into primitives).

The problem has aroused considerable interest owing to its wide range of applications and to the ever increasing availability of geometrical sensors. This has resulted in a significant increase in the availability of scanned geometrical models, which does not mean that their quality is improving: although many users have access to high-precision acquisition systems, the recent tendency is to replace these costly tools by a heterogeneous combination of consumer acquisition devices. The measurements produced by the latter are not able to undergo a direct processing. This is even more the case if it is desired to merge the heterogeneous types of data coming from the various consumer sensors. Similarly, the diversity of geometrical processing tools results in an increase in the number of errors in the data: the conversion from and to various geometrical representations often has the effect of a loss of quality with respect to the input signal. Algorithms that provide, at their output, guarantees of a quality better than their requirements in terms of input signal are rare.

Discretizations with more and more refinement are employed for capturing complex geometrical shapes. This means that the emphasis becomes that of offering strict geometrical guarantees, so as to be robust against the appearance of artifacts and to make possible the certification of the algorithms.

The term “geometrical guarantees” is understood to mean the fixing of a maximum for the errors in the geometrical approximation, and the absence of self-intersections.

In addition, there are topological guarantees, such as homotopy, homeomorphism or isotopy; these notions are defined hereinbelow.

In this instance, isotopy means that there exists a continuous deformation which deforms one shape into another, while at the same time maintaining a homeomorphism between these two shapes.

Surface meshes offering these guarantees are required in order to obtain a rendering without artifacts, for digital engineering, for reverse engineering, for manufacturing and for 3D printing.

The geometrical simplification allows the number of primitives to be reduced. The topological simplification can repair holes and degeneracies present in the existing discretizations. These two types of simplification may be used in combination for reconstructing real shapes starting from the raw geometric data such as point clouds or triangle soups.

Numerous techniques have been proposed over the years for carrying out digital shape approximations. Few of them provide a majorant for errors.

The document [Ref1.] (Appendix 2) has provided a method for polynomial time approximation with a guarantee of going down to a minimum number of vertices for a given maximum error tolerance. However, this result is purely theoretical, and this document does not offer any practical algorithm for its implementation.

The ‘maximum error’ approximation has also been studied by clustering in [Ref18], by mesh decimation [Ref9], [Ref15], [Ref10], [Ref28], or else by a combination of these two techniques [Ref24].

In general, the error metric being considered is the unidirectional Hausdorff distance which goes back to the input mesh, but some have used the bidirectional distance [Ref 9].

Generally speaking, these approaches are not sufficiently generic for working on heterogeneous and imperfect input data, and they do not allow an output without intersections to be guaranteed.

Creating intersections during the mesh decimation ([Ref26]) can be avoided, but this is not sufficient in the case of input data which itself comprises self-intersections, and these avoidances imply a premature end to the simplification phase and which, at the end of the day, result in meshes that are too complex.

Generally speaking, it is important to generate a mesh at the output which is isotopic to the input data, and which is happy with a small number of triangles (or of vertices). In 2D, this is known as the problem of ‘minimum nested polygons’, and has been well studied in the convex case [Ref22]. In 3D, this becomes the problem of ‘minimum nested polyhedrons’, which has been shown to be of NP-hardness.

Although this problem is old, there is still no robust and practical solution to this scientific and technical challenge. The present invention is aimed at providing such a solution.

The method provided for this purpose starts with a tolerance volume Ω as input data.

The tolerance volume may be determined, in the framework of a pre-processing, starting from initial raw geometric starting data, for example on the basis of a point cloud or of a triangle soup, or else starting from any given set of geometric data, even heterogeneous data.

The method provided comprises the following steps:
A. receive a tolerance volume Ω relating to raw geometric starting data,
B. initiate a canonical triangulation within the tolerance volume, using a set S of sample points taken from the limits of this tolerance volume, and points situated outside of the latter,
C. refine this canonical triangulation, until the points of the sample are classified, which supplies a dense primary mesh, of the right topology, for the tolerance volume, and
D. simplify this dense mesh by triangulation modification operations, while preserving the topology and the classification of the points of the sample.

A device for processing geometric data is also provided, comprising:
A memory for geometric data, for receiving graphical data representing a tolerance volume,
An initialization member, arranged for performing a first canonical triangulation between the edge of the tolerance volume and points situated outside of the latter,
A refinement member, arranged for sharpening said first triangulation until a dense mesh is obtained for the tolerance volume, which preserves a classification condition for the points of the triangulation,
A simplification member, arranged for simplifying said dense mesh, while preserving the topology and the classification of its points, and
A pilot that successively activates the initialization member, the refinement member, and the simplification member, for graphical data that varies starting from the same tolerance volume.

Other features are also provided, both for the method and for the corresponding device.

The initialization step B may comprise the sub-step for sampling the limits of the tolerance volume according to a chosen sampling density σ, which supplies the set S of sample points.

The step B may comprise the marking of each sample point of the set S with a label value, which represents the index of the boundary connected component of this point, within the tolerance volume. The refinement step C then comprises the iterative generation of the canonical triangulation, inserting one point at a time, on at least a part of the set S of points, until all the points concerned verify a classification condition based on the value of a function F, itself dependant on their index value, and on its interpolation by an interpolation function f applied to each mesh element of the 3D triangulation.

Thus, a point classification operator may be used, which receives the designation of a point to be processed, and determines an interpolation function f on the basis of the mesh element surrounding this point to be processed, and of label values relating to the vertices of this mesh element, so as to supply an interpolated label and to compare the latter with a current label of the point to be processed, which allows the determination of a classification condition of the point to be processed.

The step C may be completed by the piece-wise construction of a linear isosurface Zset, by using the points where the interpolation function f has the same chosen intermediate value, in particular zero, this isosurface Zset being a closed surface which forms a surface approximation of the tolerance volume.

Preferably, the canonical triangulation is a Delaunay triangulation.

The raw geometric starting data may be 2D data or 3D data.

For its part, the simplification step D. may comprise the following operations:

D1. determine whether triangulation modification operations are valid, in other words preserve the topology of the mesh and preserve the classification condition of the set S of sample points, and
D2. carry out the valid triangulation modification operations in a given order.

Preferably, the triangulation modification operations comprise collapsing (or merging) of edges and/or collapsing of half-edges.

The order may be determined according to an optimization criterion.

In one embodiment, the step D. relates to a volume referred to as “simplicial tolerance” which approximates the tolerance volume by a union of mesh elements of the canonical triangulation, the isosurface Zset being contained within this volume referred to as “simplicial tolerance”,

The steps D1 and D2 may then be carried out:
Firstly, on the boundary of the volume called “simplicial tolerance”,
Subsequently, on the product of a mutual triangulation between the isosurface (Zset) and the volume called “simplicial tolerance”, this mutual triangulation adding vertices, edges and mesh elements into the triangulation, on the isosurface,
Lastly, with other edges contained within the volume called “simplicial tolerance”, all the possible edges are covered.

The invention is also aimed at a computer program product comprising portions of program code for implementing the aforementioned method or device, when the program is executed on a computer.

Other features and advantages of the invention will become apparent upon examining the description detailed hereinafter, and from the appended drawings, in which:

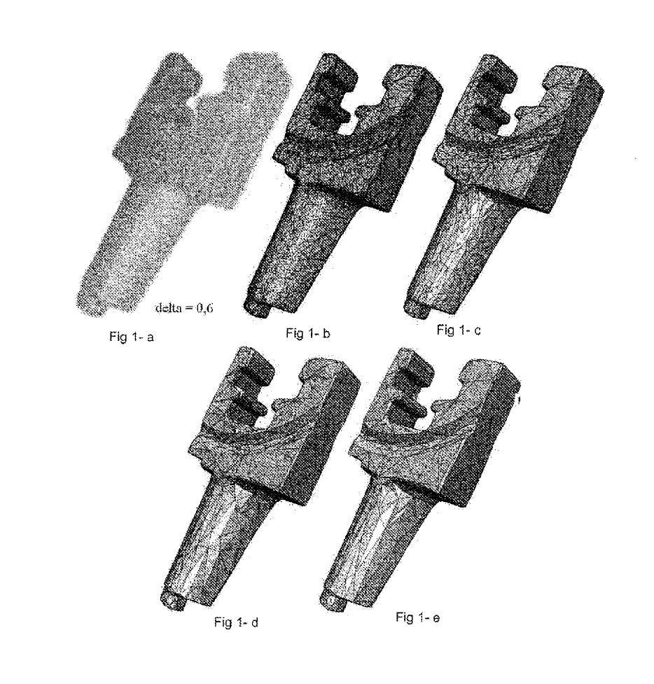

FIG. 1-a to 1-e illustrate schematically a first exemplary application of the invention;

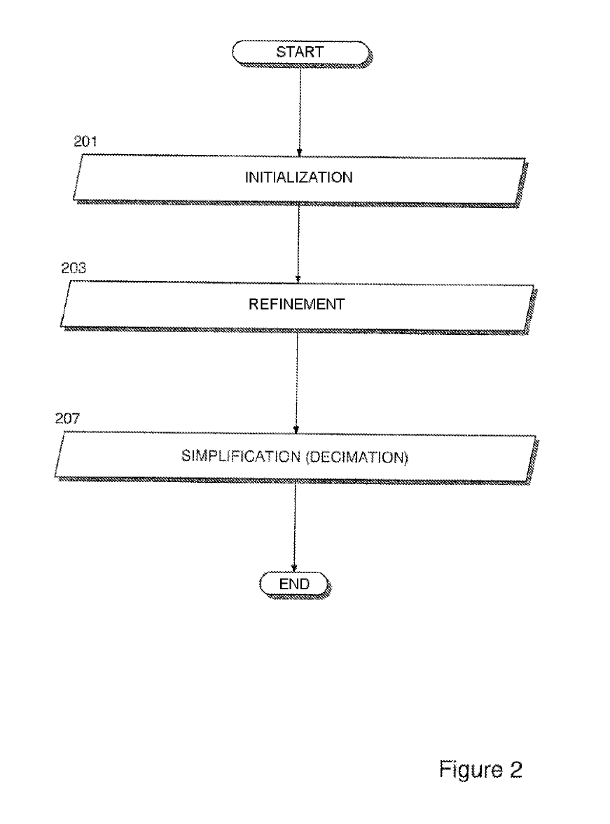

FIG. 2 is the general flow diagram of the member provided according to the invention,

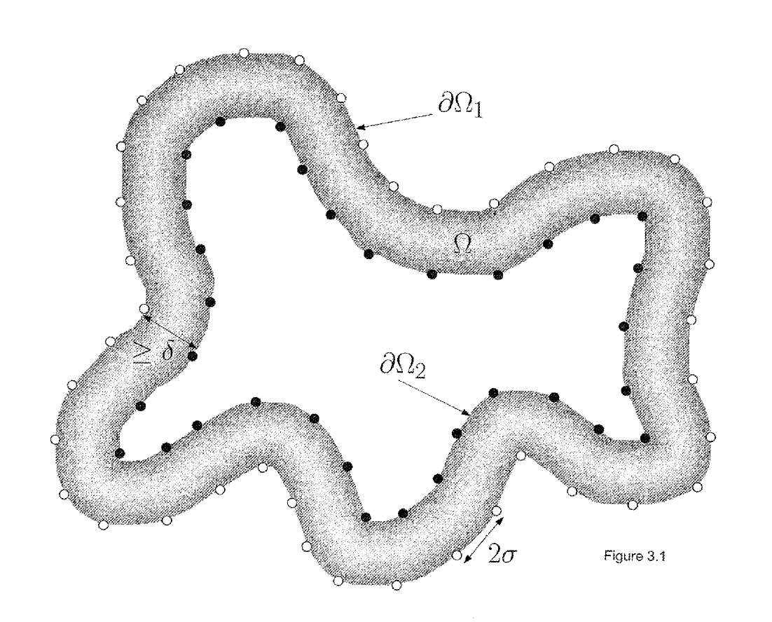

FIG. 3 illustrates one example of the start of application of the invention.

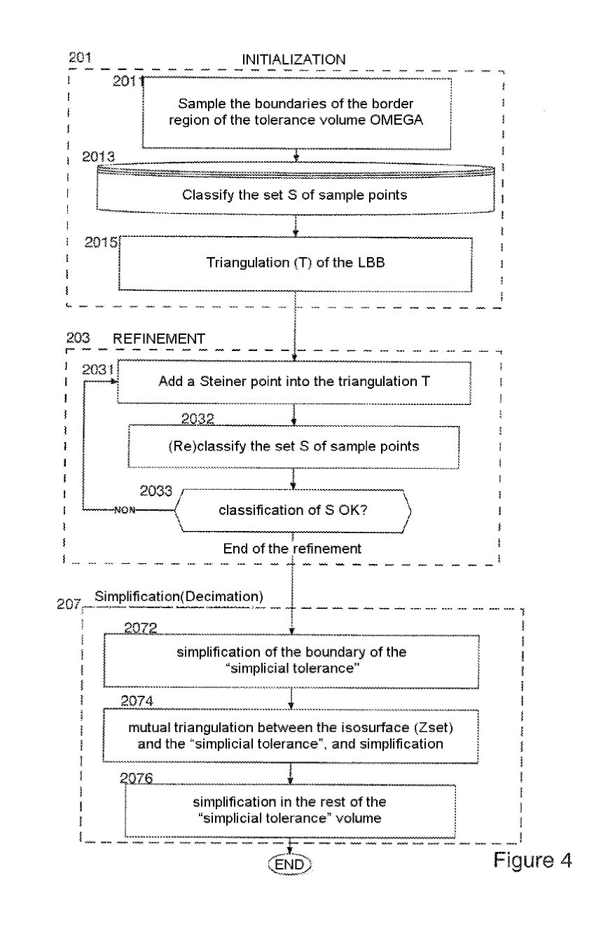

FIG. 4 is a flow diagram detailing that in FIG. 2,

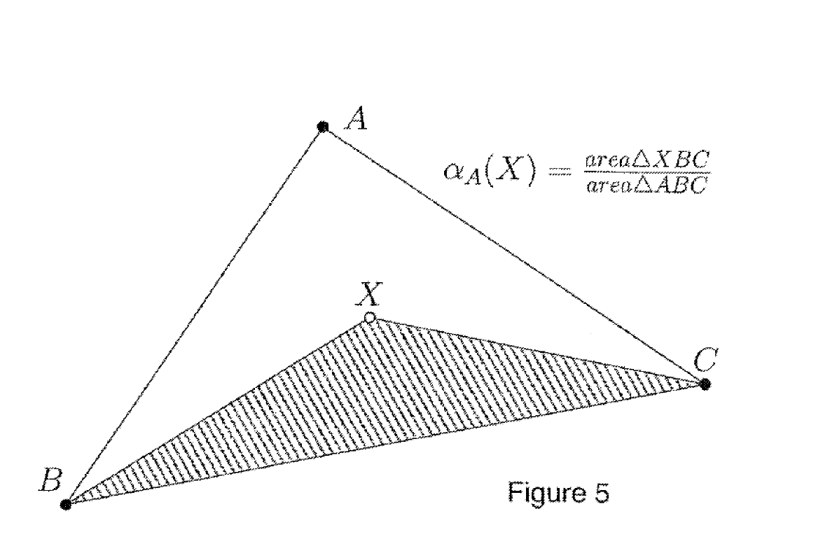

FIG. 5 is a drawing illustrating the definition of barycentric ratios,

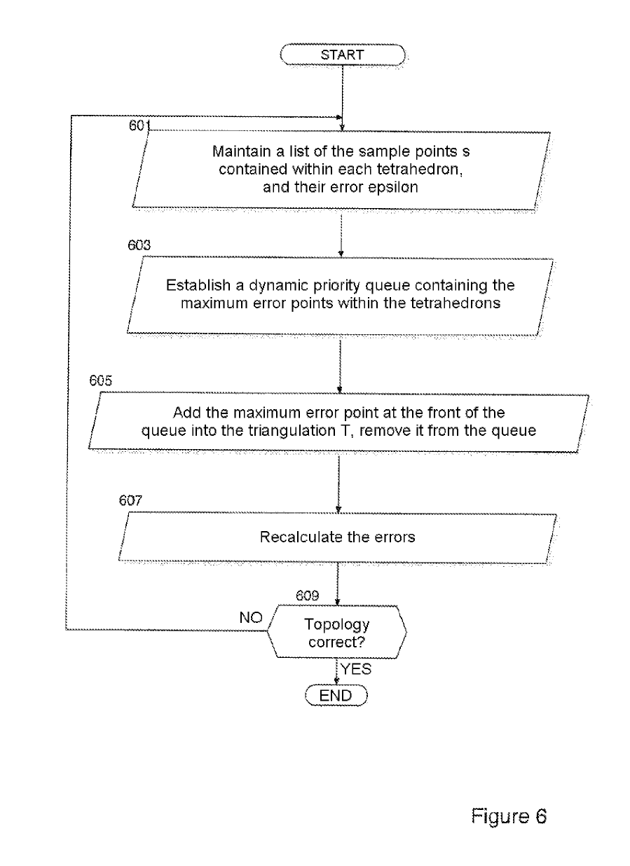

FIG. 6 is a flow diagram detailing a preferred embodiment of the refinement step 203 in FIGS. 2 and 4,

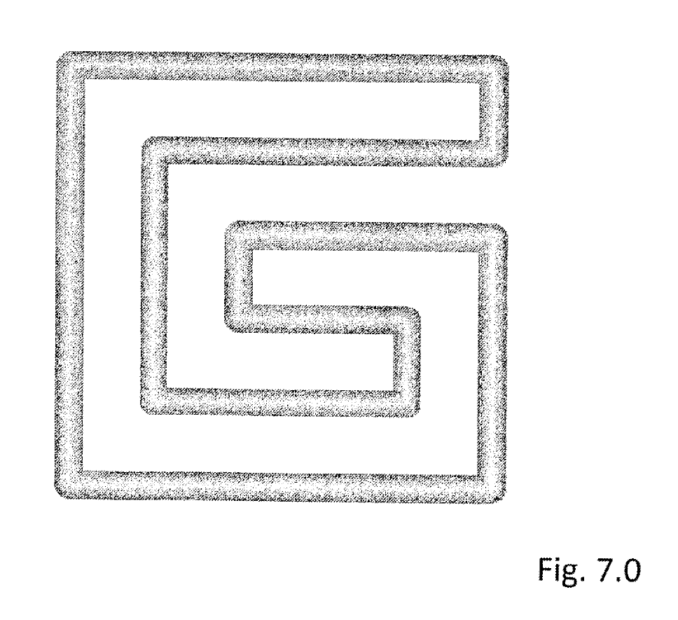

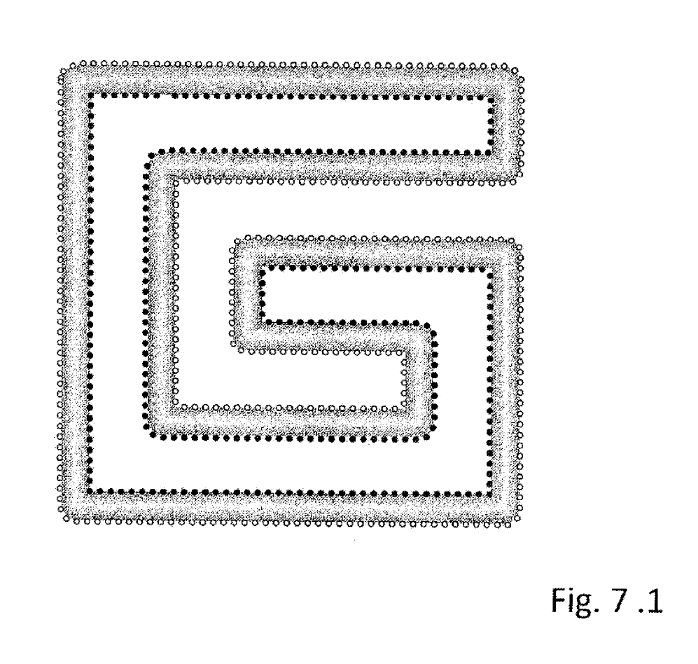

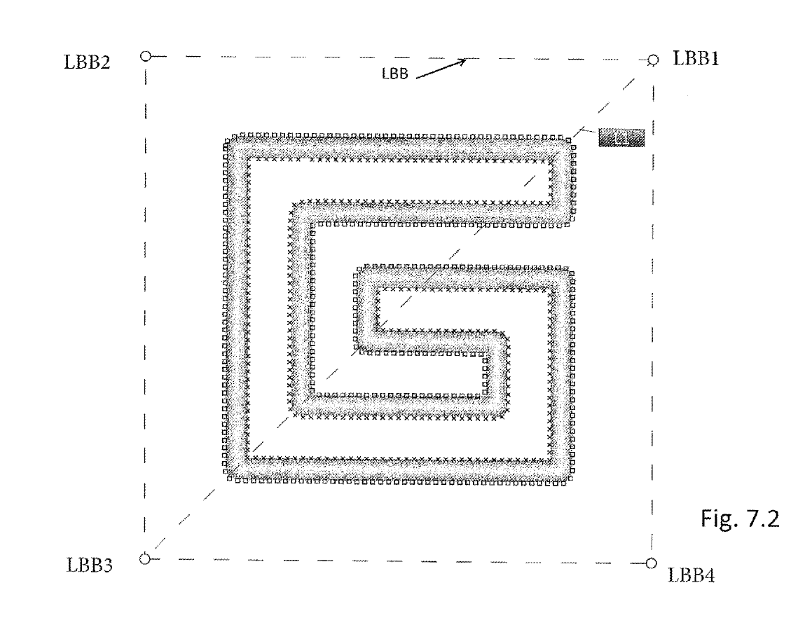

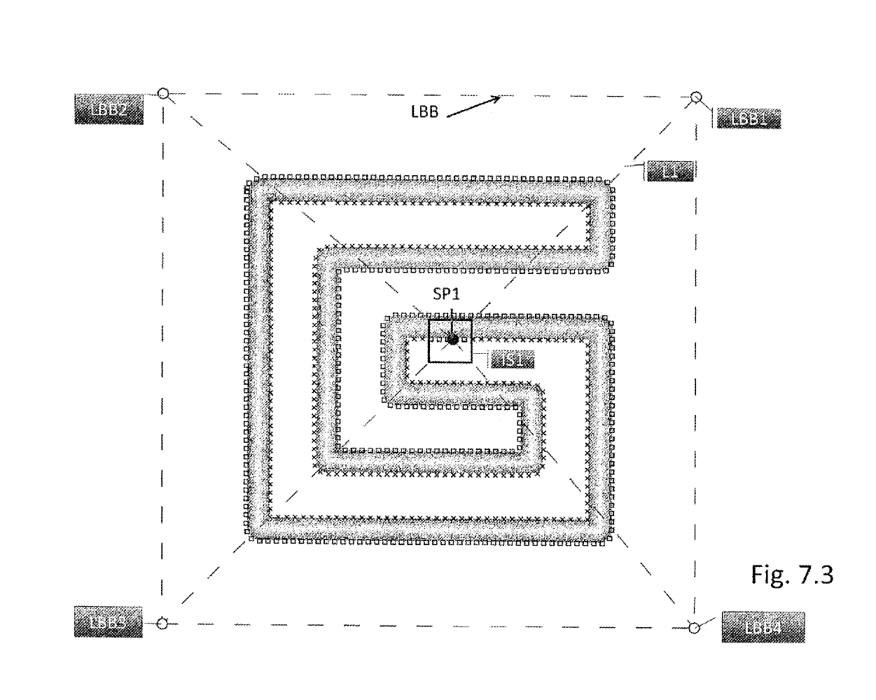

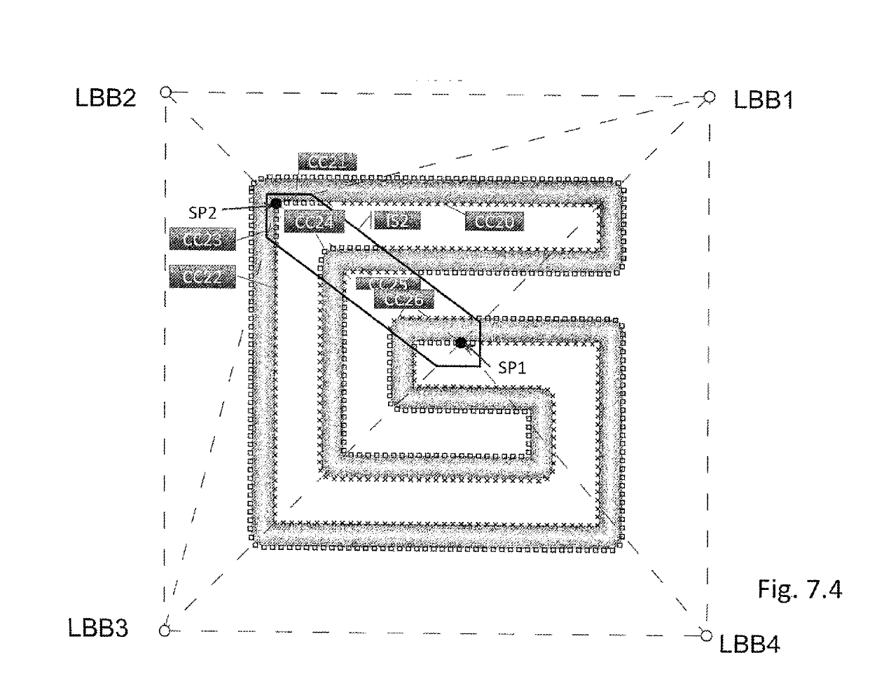

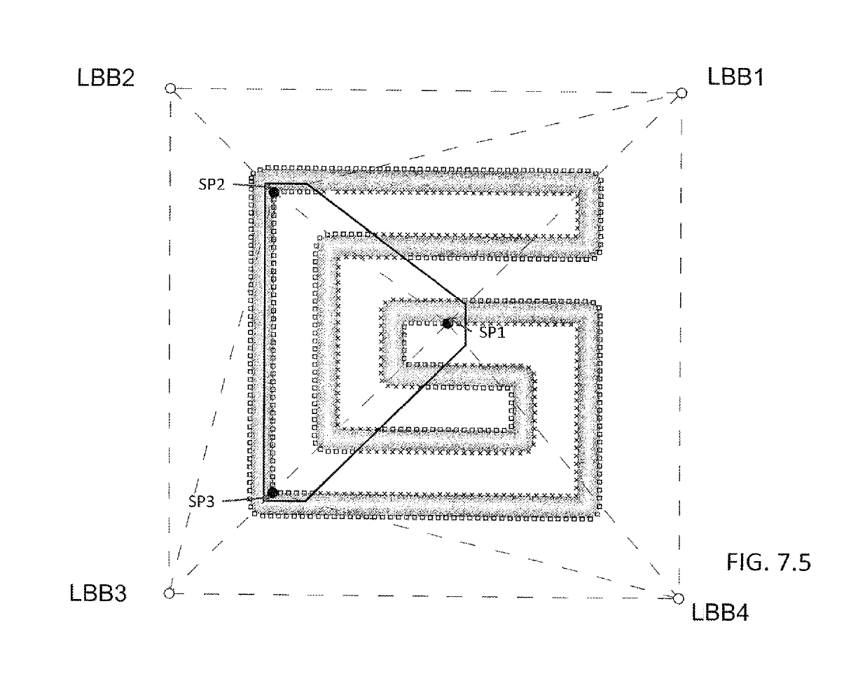

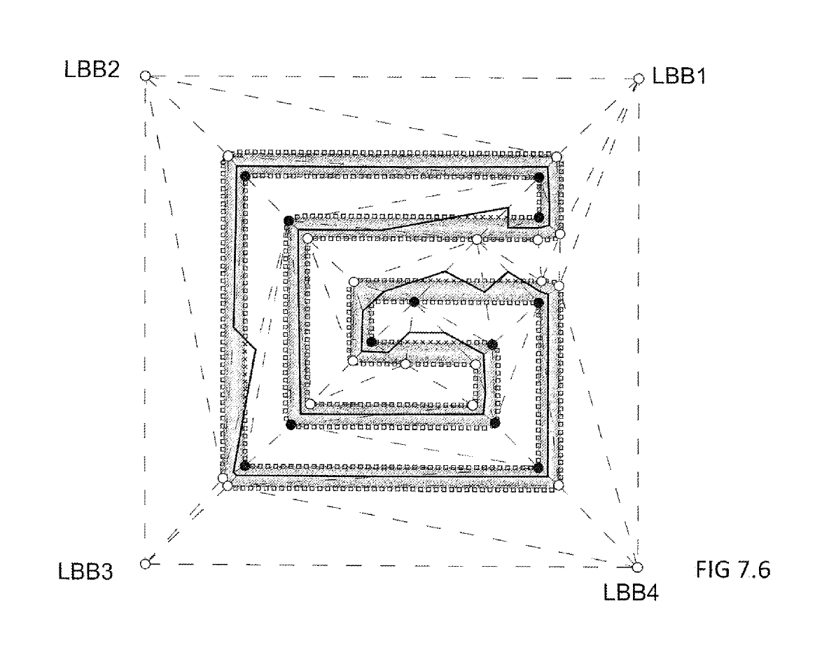

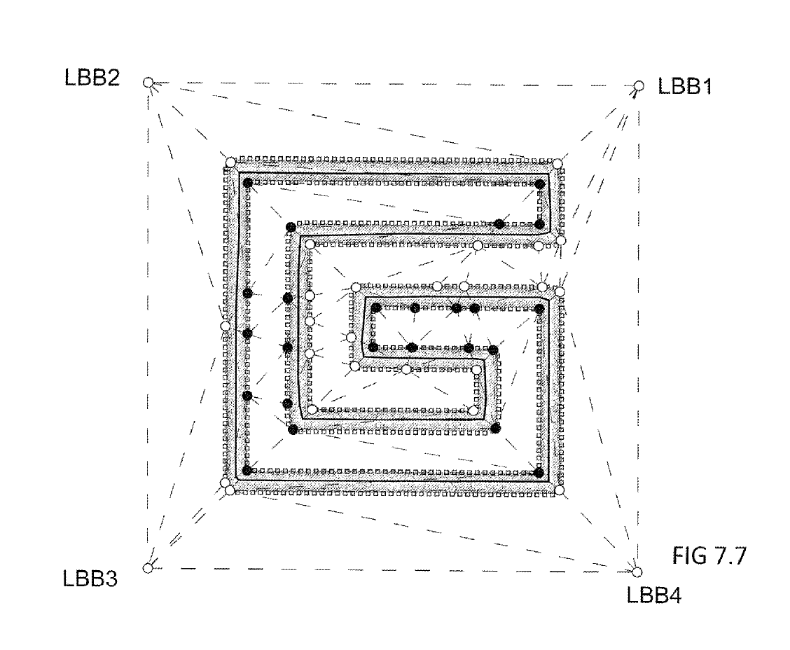

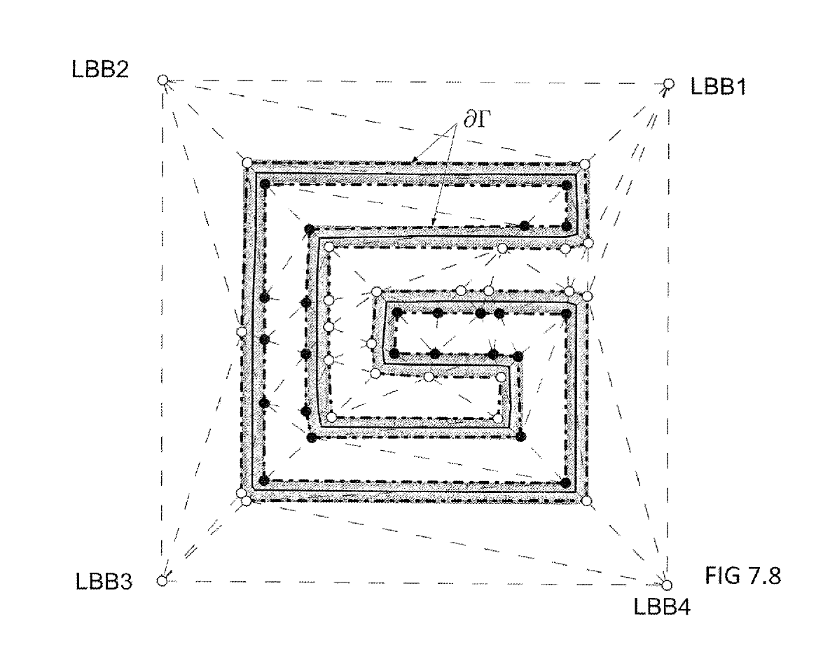

FIG. 7 show various states of the triangulation during the refinement phase, on another, very geometrical, example of application of the invention,

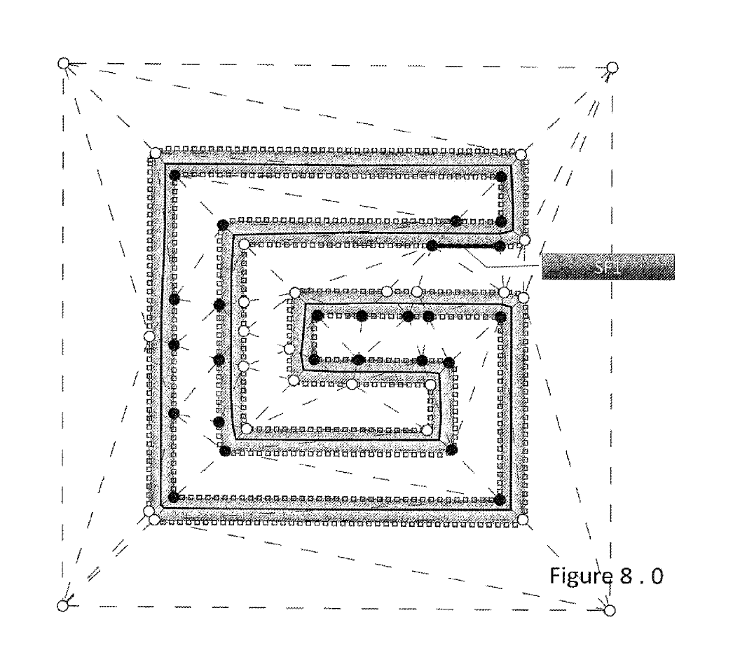

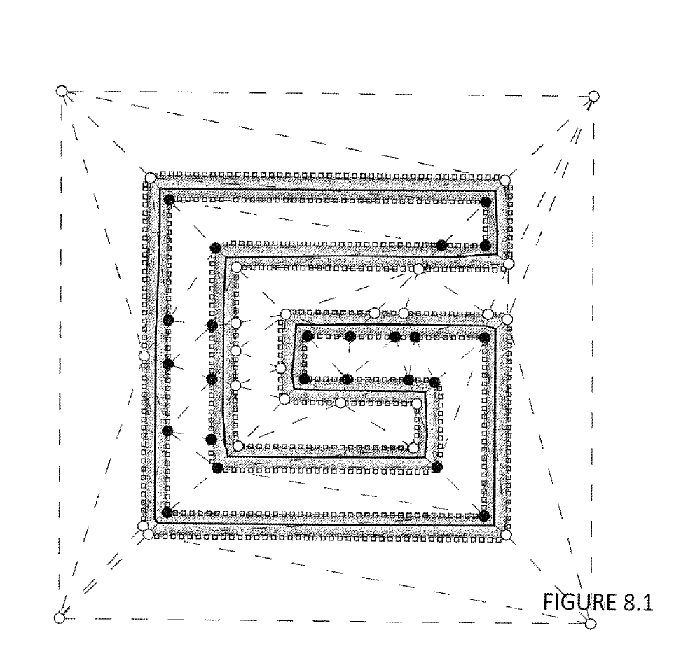

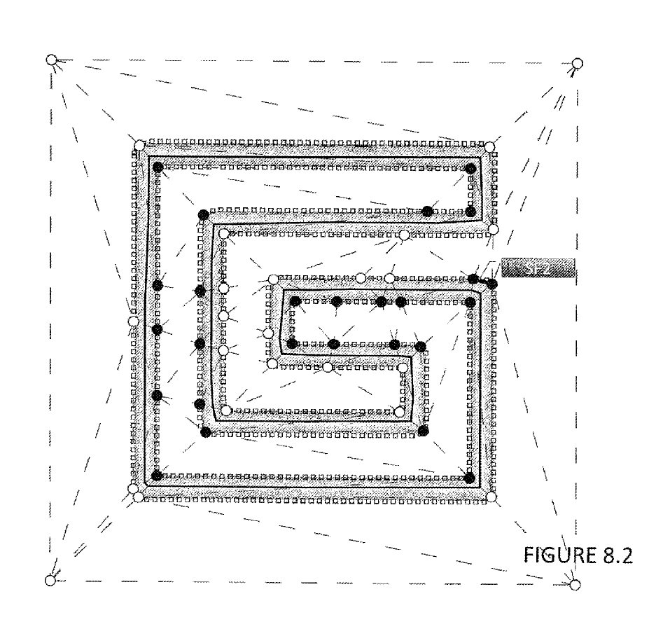

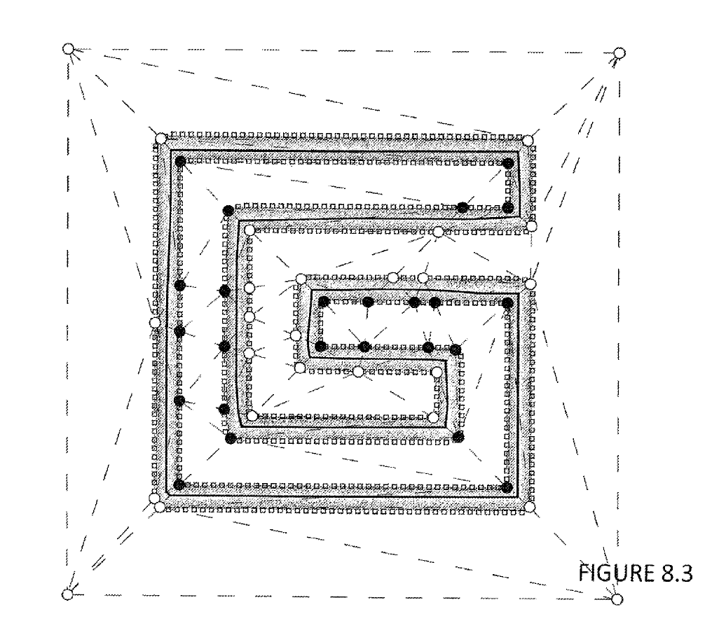

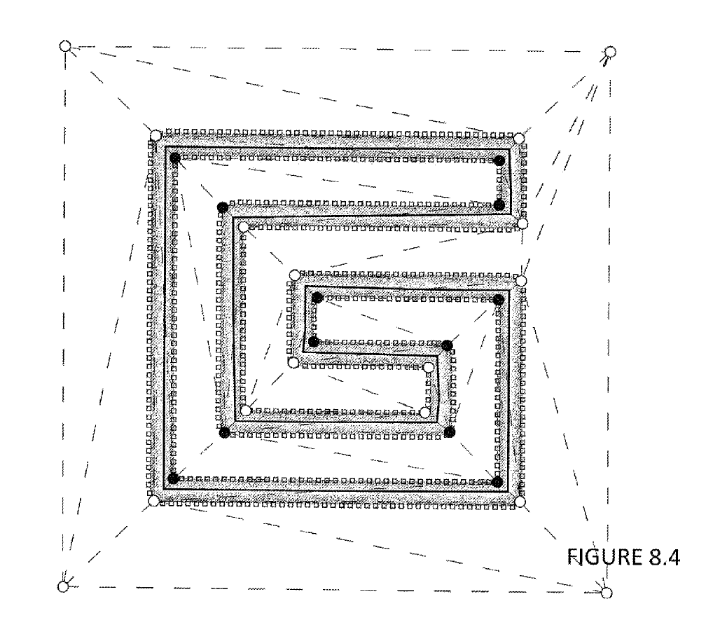

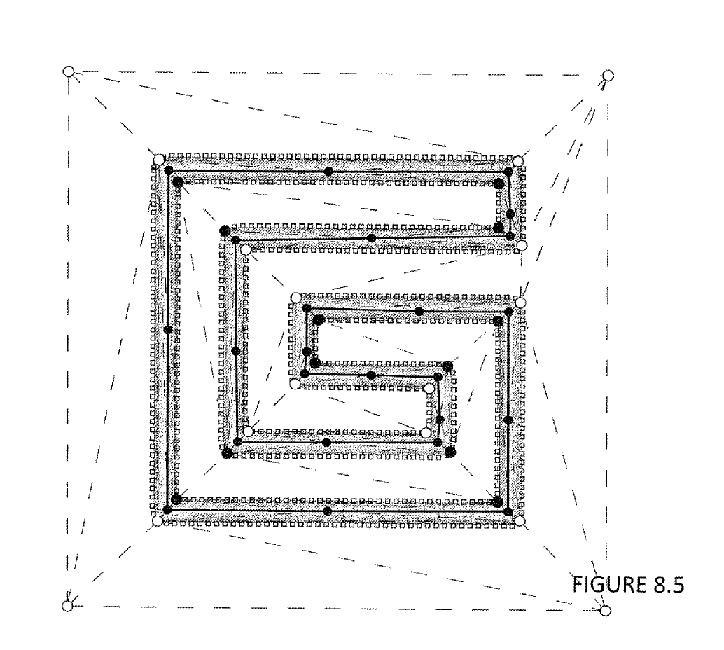

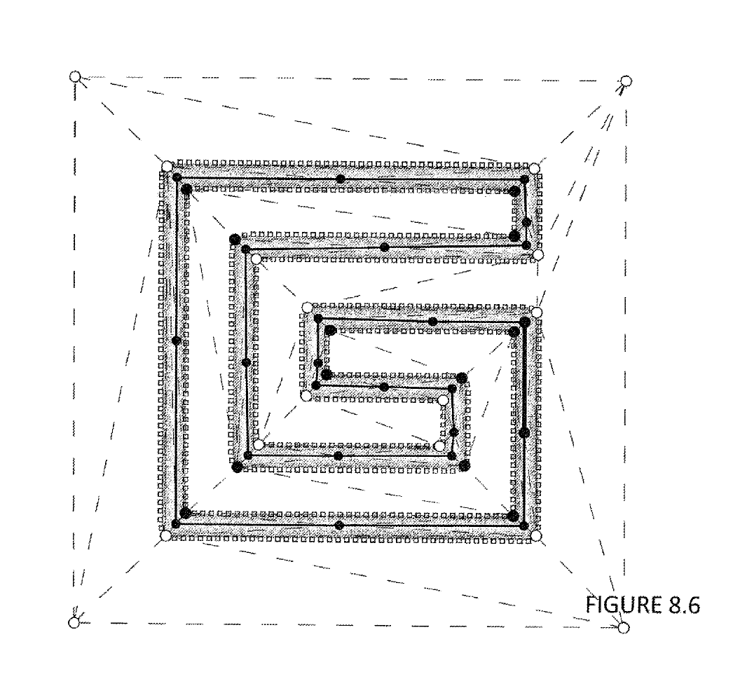

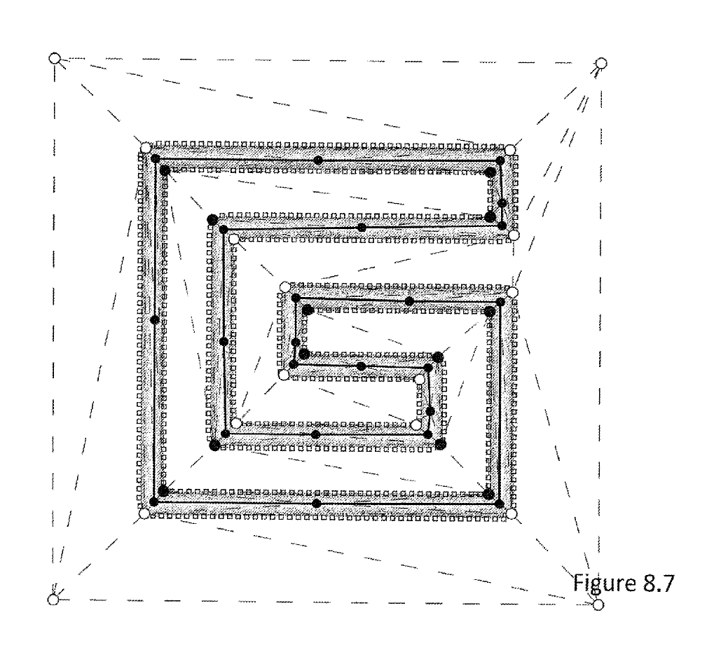

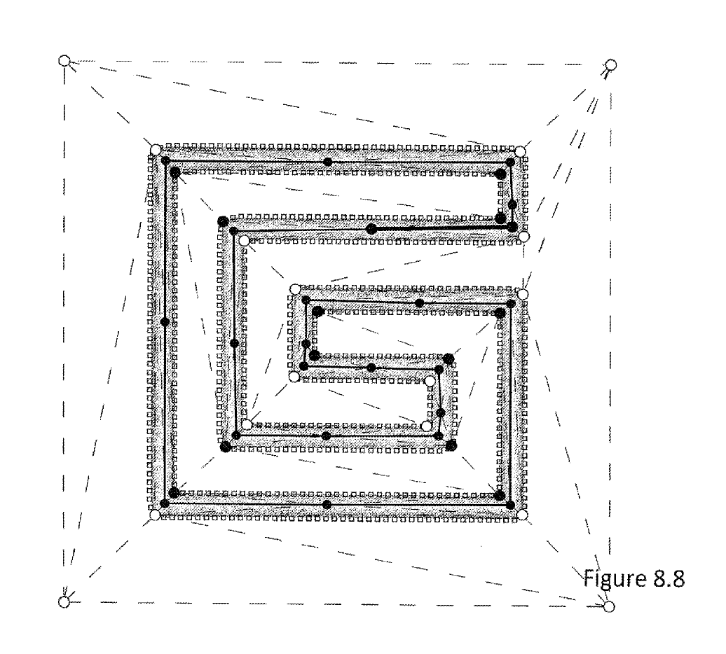

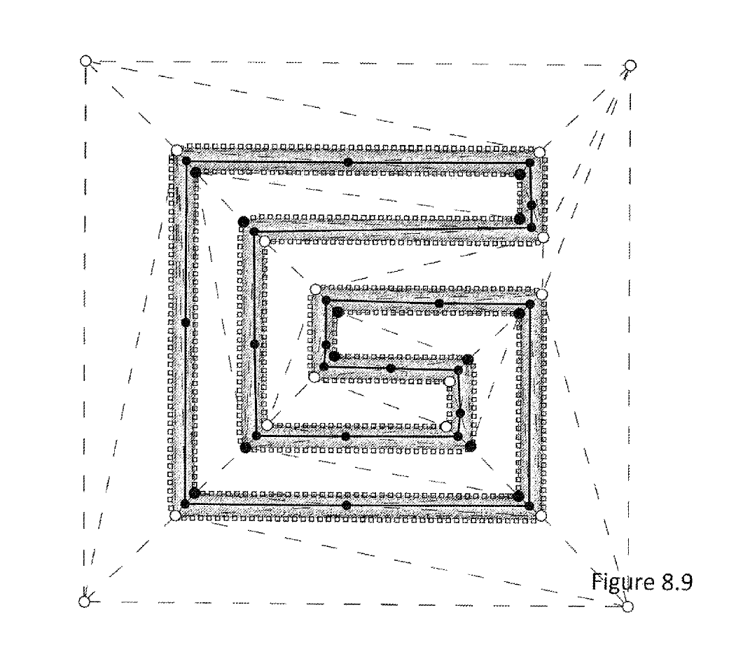

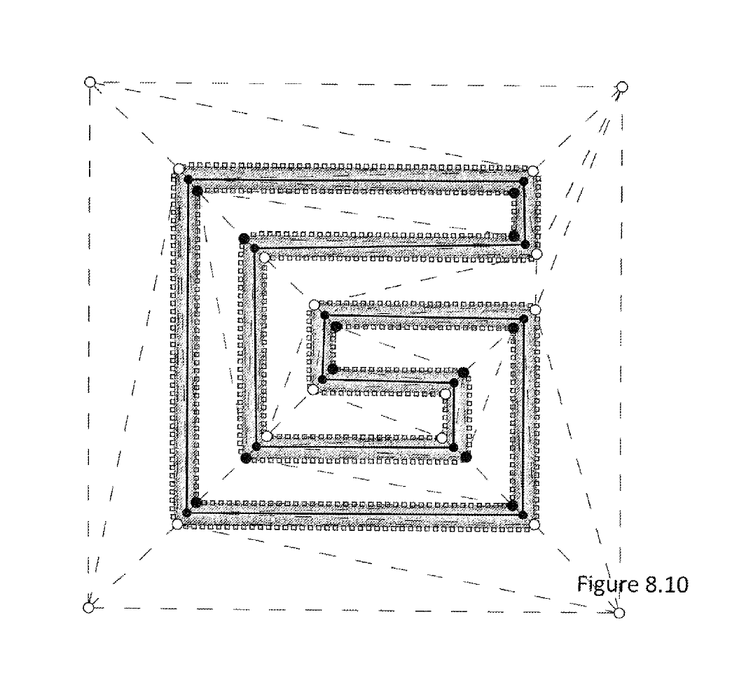

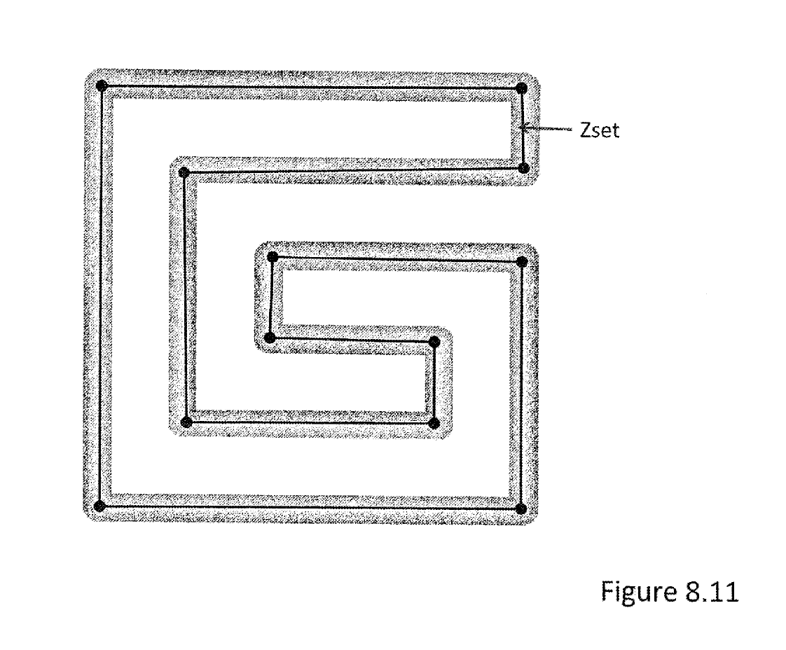

FIG. 8 show various states of the triangulation during the simplification phase, on the same, very geometrical, example of application of the invention,

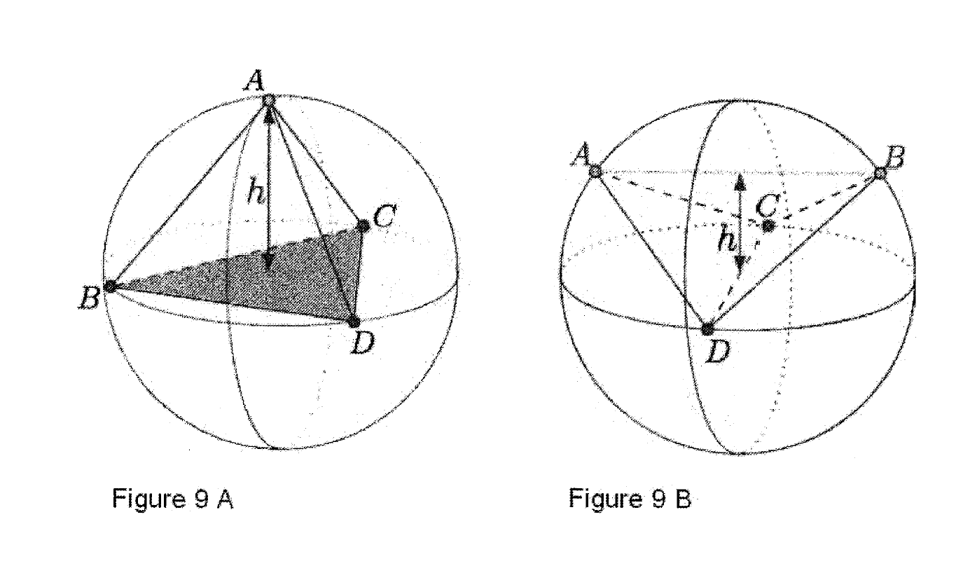

FIG. 9 are drawings illustrating one particular case of application of the invention,

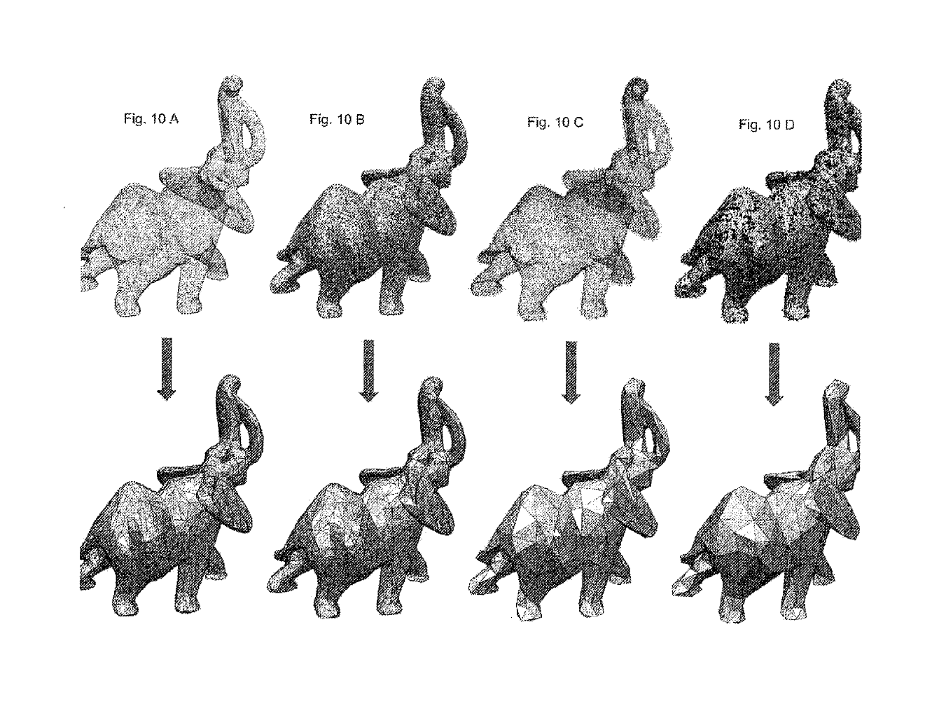

FIG. 10 are representations of elephants showing the robustness of the method according to the invention,

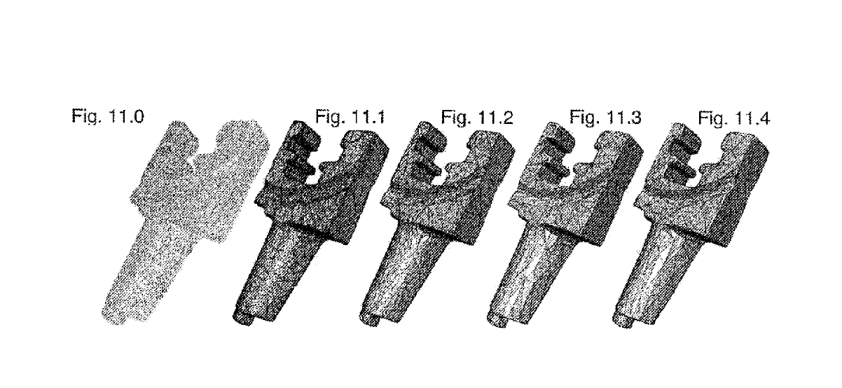

FIG. 11 illustrate schematically other examples of application of the invention, on the same object as FIG. 1,

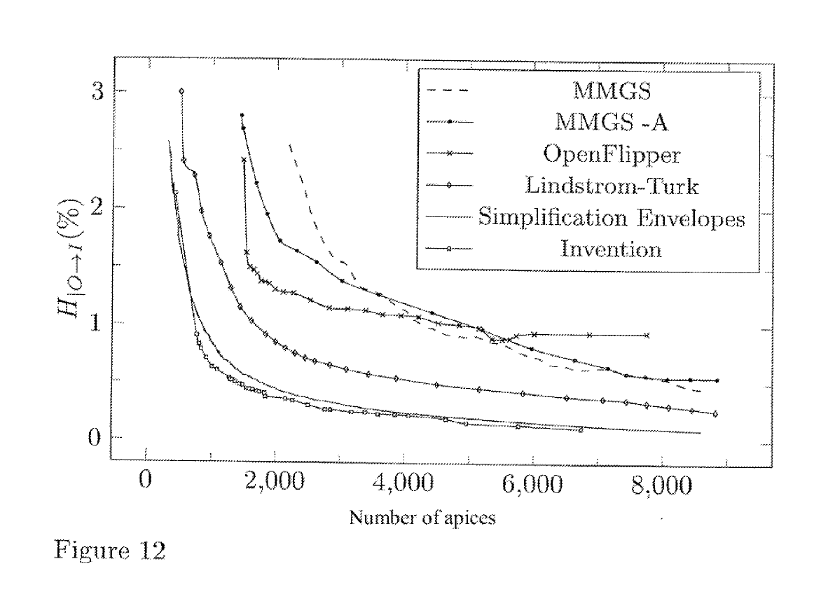

FIG. 12 is a diagram illustrating some advantages of the invention,

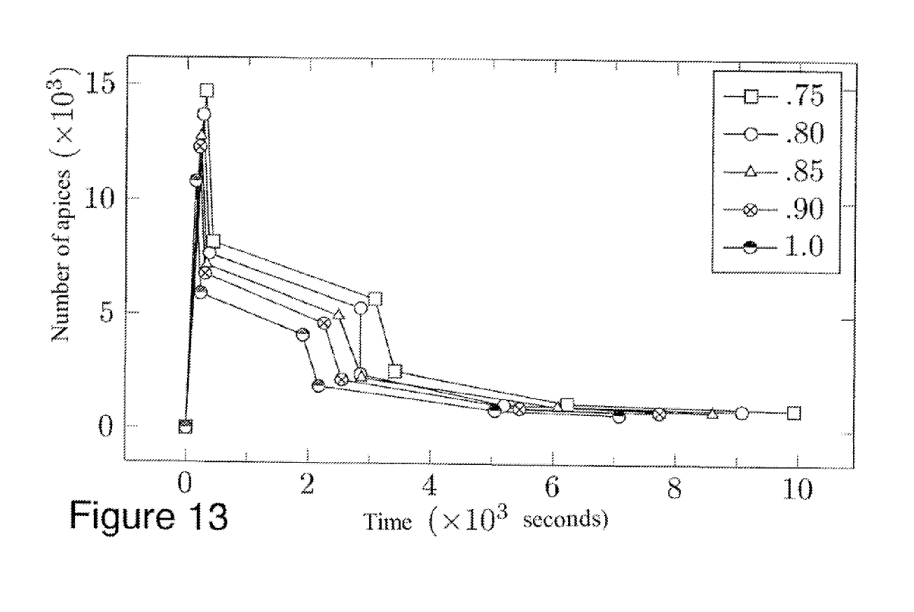

FIG. 13 is another diagram illustrating some advantages of the invention,

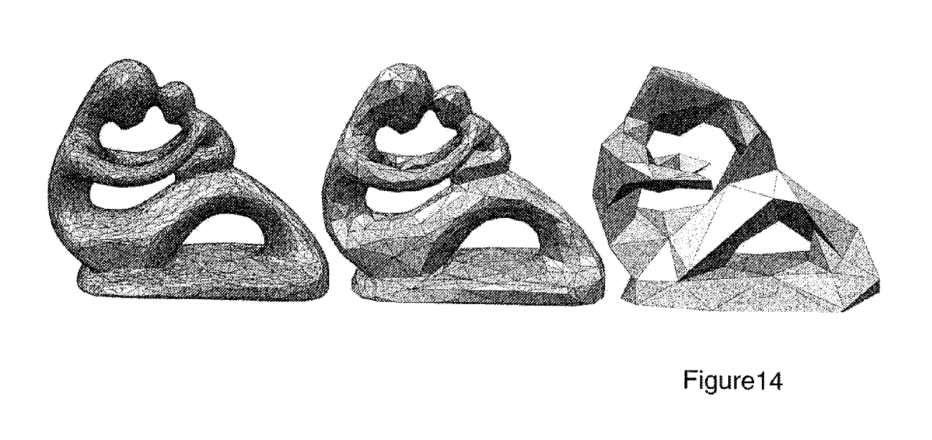

FIG. 14 is another representation, referred to as “fertility”, to which the diagrams in FIGS. 12 and 13 relate,

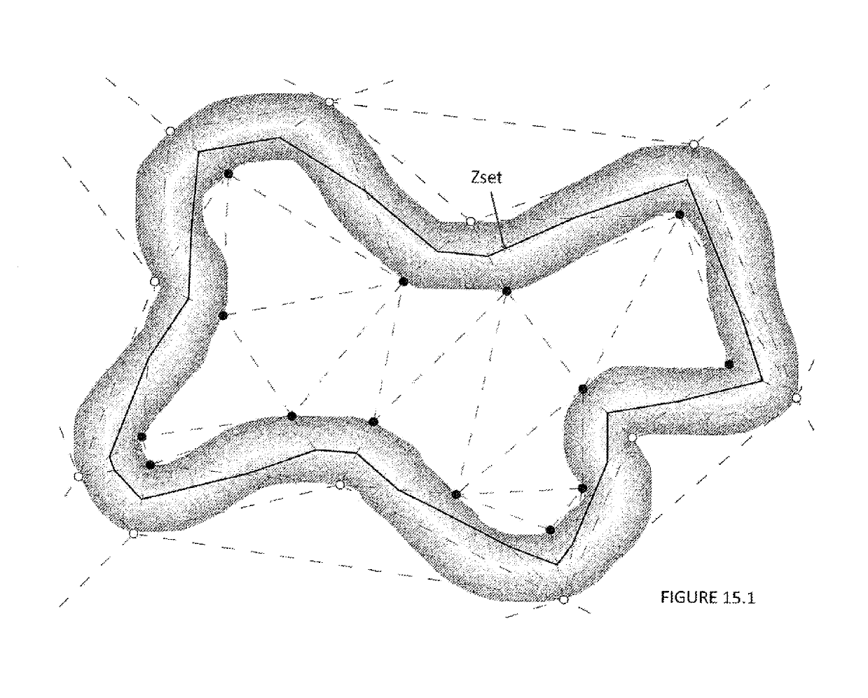

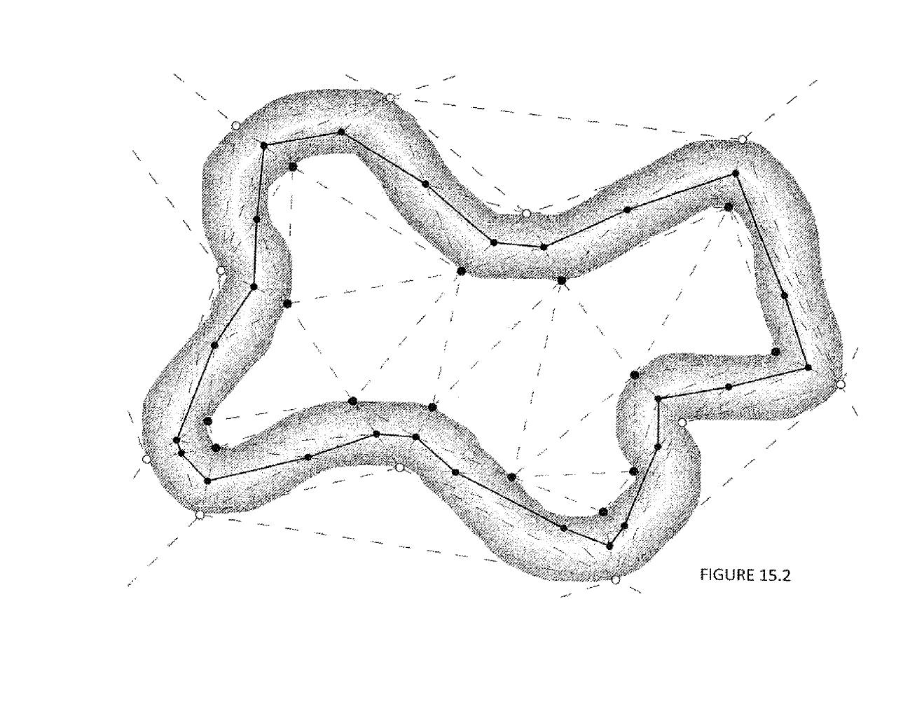

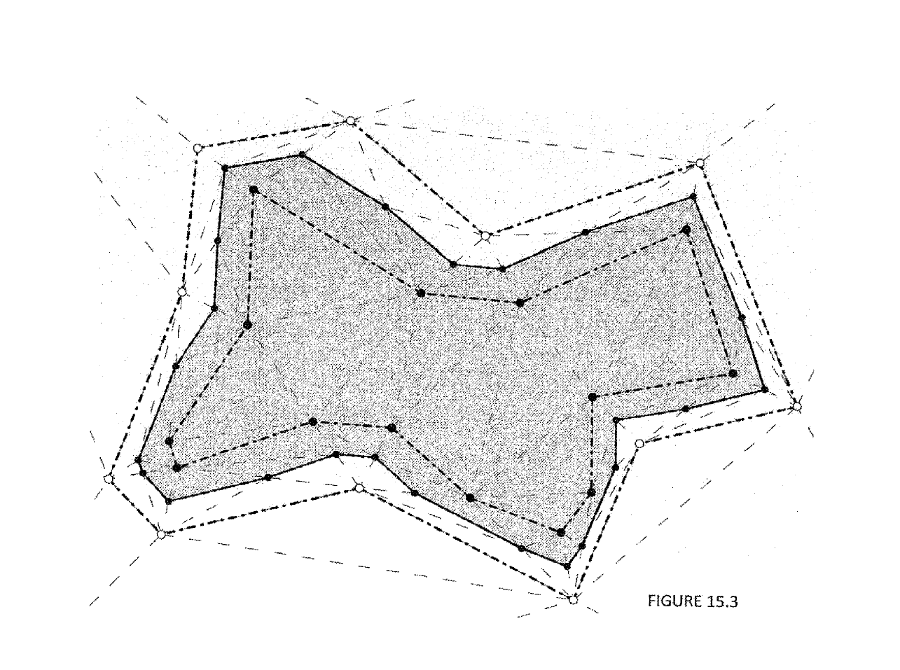

FIG. 15 are representations comparables to that in FIG. 3, allowing the mutual triangulation sub-phase of the simplification phase to be better understood.

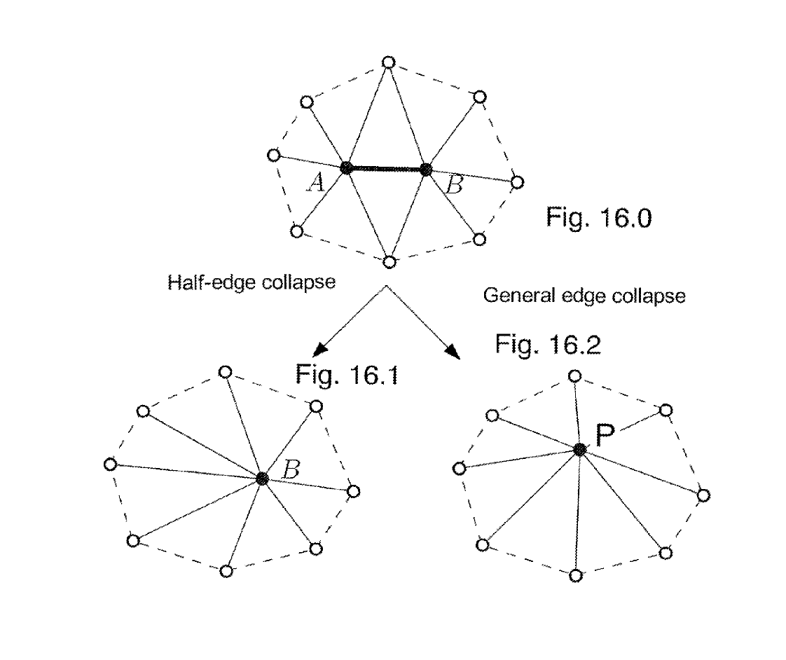

FIG. 16 illustrate two members for collapsing edges and half-edges,

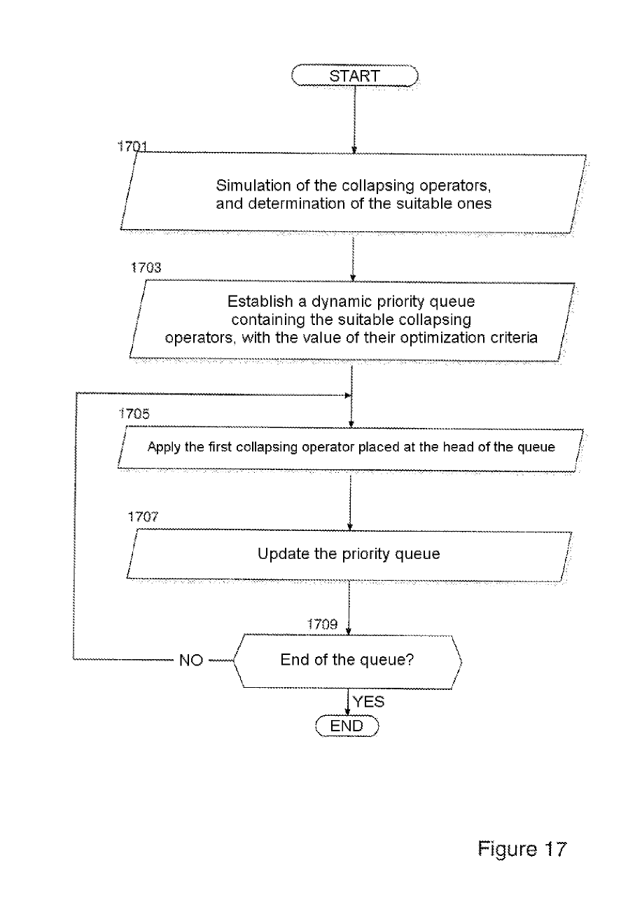

FIG. 17 is a flow diagram detailing a preferred embodiment for the simplification step 207 in FIGS. 2 and 4,

FIG. 18 is the functional flow diagram of a device according to the invention, and

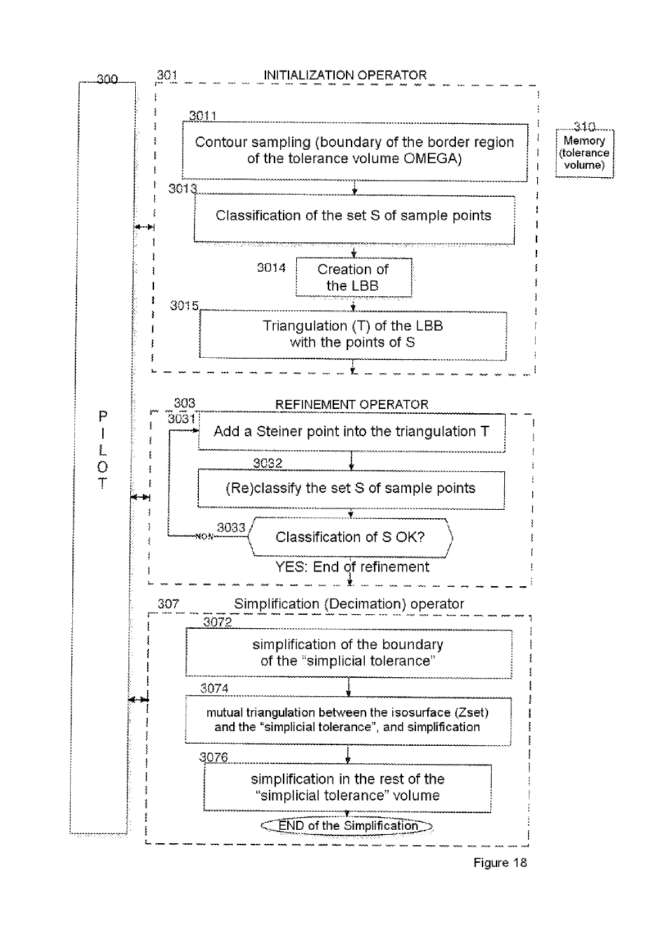

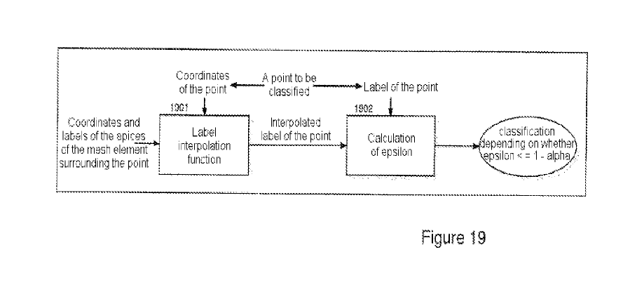

FIG. 19 is the functional flow diagram of a classification operator used according to the invention.

The drawings and the description hereinafter essentially contain elements that are certain. They could therefore not only be used for a better understanding of the present invention, but also to contribute to its definition, where appropriate. The nature of the invention means that certain features can only be fully expressed by the drawing.

The description is followed by an Appendix 1 comprising definitions, and by an Appendix 2 grouping the coordinates of the documents to which reference is made here. These Appendices form an integral part of the description.

FIGS. 1a to 1e will firstly be examined, for a very general description of the invention, presented with reference to FIG. 2, which illustrates the main operational steps of the method provided, and to FIG. 4 which details FIG. 2.

FIG. 1-a illustrates the starting point, namely a tolerance volume Ω relating to a mechanical component measured by a laser scanner, with an input tolerance δ of 0.6%.

FIG. 1-b illustrates what is obtained after the refinement step (203, FIG. 2). The result is a piecewise linear function Z, corresponding to a surface mesh of the tolerance volume Ω in FIG. 1. The number of vertices is 20.4 k (20.400).

Simplifications are subsequently carried out, according to the step 207 (FIG. 2).

FIG. 1-c illustrates the same mesh as FIG. 1.b, but after it has undergone a first simplification (simplification of the boundary ∂Γ of the “simplicial” tolerance Γ, step 2072, FIG. 4), which takes it down to 5.3 k vertices.

FIG. 1-d illustrates the same mesh, after mutual triangulation and simplification of Z (step 2074, FIG. 4), which takes it down to 1.01 k vertices.

Lastly, FIG. 1-e illustrates the mesh after simplification (step 2076, FIG. 4) which is further reduced to 752 vertices.

It can be observed, by eye, that, even simplified, the mesh in FIG. 1-e is a good representation of the object defined by the preceding figures.

Reference is now made to FIG. 3, which uses a symbolic curvilinear tolerance volume, simpler than that used in FIG. 1.

It has been seen that FIG. 2 illustrates the main operational steps of the method provided. FIG. 4 illustrates certain steps of the method in more detail.

In FIG. 3, the tolerance volume Ω is defined by an buoy-like curvilinear shape, whose boundary ∂Ω has two borders ∂Ω₁ and ∂Ω₂, in a plane cross-sectional view.

The step 201 in FIGS. 2 and 4 is an initialization. As indicated at 2011 (FIG. 4), the initialization firstly comprises a sampling of the boundary (or of the border) of the tolerance volume.

A set S of sample points s is obtained, stored at the step 2013 (FIG. 4). This sampling is in principle “σ-dense”. This means that balls of radius 6 centered on all the points s of S entirely cover the border region ∂Ω of the tolerance volume Ω. In practice, σ is a fraction of the thickness δ of Ω.

In the simplest case, that in FIG. 3, the boundary ∂Ω has only two border surface connected components, namely ∂Ω₁ (outer border) and ∂Ω₂ (inner border). In this case, the interior and the exterior from one end to the other of the boundary ∂Ω are easily distinguished. This can be done formally by assigning to each sample s of the set S a label value F(s) which is, for example:

F(s)=1 if the points is on ∂Ω₁, and
F(s)=−1 if the points is on ∂Ω₂.

This value F(s) may be seen as a representation of the index of the boundary connected component of the points in question, within the tolerance volume.

Another function ‘f’ is constructed: for a point x, present within a mesh element M (triangular in 2D, tetrahedral in 3D), a linear interpolation function f(x, M) is calculated, defined on the basis of the values F(s) at the three or four vertices of the mesh element M (triangle or tetrahedron), and of the barycentric coordinates of the point x in question, with respect to the vertices of the mesh element. More precisely, f(x, M) is a convex linear combination of the values of F at the vertices vi of the mesh element M:

f(x,M)=ΣᵢαᵢF(vᵢ)

where, for all i, αᵢ is positive or zero, and the sum of the αᵢ is 1. The values of αᵢ are for example defined as indicated in FIG. 5:

For a point X situated within a triangular mesh element ABC, one of the αᵢ is the value α for X with respect to the vertex A of the triangle, denoted α_{A}(X), which is the ratio of the surface area of the triangle XBC to the surface area of the triangle ABC.

### Therefore:

f(x,M)=α_{A}(X) F(A)+α_{B}(X) F(B)+α_{C}(X) F(C)

It is the same thing with a tetrahedral mesh element, which comprises one more vertex and where the surfaces become volumes.

For a point X situated within a tetrahedral mesh element ABCD, the value α for X with respect to the vertex A of the tetrahedron, denoted α_{A}(X), is the ratio of the volume of the tetrahedron XBCD to the volume of the tetrahedron ABCD. And the formula becomes:

f(x,M)=α_{A}(X) F(A)+α_{B}(X) F(B)+α_{C}(X) F(C)+α_{D}(X) F(D)

In 3D, in the case of tetrahedrons, the interpolated function f(x, M) is constrained to be a function which verifies the condition known as the Lipschitz condition (having a limited derivative). Those skilled in the art know how to implement this additional condition, which is imposed during the refinement. Examples of this will be given hereinbelow, with reference to FIG. 9.

Other information on these barycentric calculations is available in [Ref25].

Besides this, the set of the points p where f(p)=0 corresponds to a polygonal line (a surface in 3D) called ZeroSet. This polygonal line ZeroSet, also denoted Z for short, is a piecewise linear surface, which is situated inside of the tolerance volume.

An error quantity ϵ is also used, which may be defined as follows:

ϵ (s)=| f(s, M)−F(s)|, where the notation |× | corresponds to the absolute value function of x.

Being a part of the set S, the point s has a value F(s). Within the mesh element M of the mesh which contains this point s, the latter receives an interpolated value f(s, M).

A parameter α is considered, with (0<α<1). The default value of α may be fixed at 0.2. It will then be stated that:
if ε(s)<=(1−α), that the point s is well classified with the margin α,
otherwise, that the point s is poorly classified.

A value ϵ close to 1 indicates that the mesh must be refined.

The refinement is done by adding a point x, from the set S, which does not yet belong to Sp, to the set Sp (set of points which are the subject of the triangulation). The point x inserted into the mesh has a label value F(x). The classification calculation, and that of the error ϵ, are then repeated for all the non-inserted points of the set S (in other words for all the points of the set S which do not belong to the set Sp).

It would, at least in theory, be possible to operate in an arbitrary order. It is currently preferred to start with the points which yield the largest error, and to then perform an iteration. This is what will be described hereinafter with reference to the member illustrated in FIG. 6.

It is observed that this member converges irrespective of the mode of selection of the added points: in the worst case, all the points of the sample would be added, and they are then all well classified.

In the framework of a Delaunay refinement, the points that are added to the current set of samples to be triangulated (Sp) are called “Steiner points” (not to be confused with the Fermat point of a triangle which some people also refer to as “Steiner point”).

When this is finished and all the points are correctly classified, in other words the error is <=(1−α) everywhere, a correct, but complicated, primary mesh is obtained.

The description will now be restarted with reference to FIG. 7, which are very geometrical and which facilitates its understanding. These figures illustrate a two-dimensional processing that those skilled in the art will know how to transpose into three dimensions. Only a 2D illustration is possible, as 3D figures would be unreadable since everything would be superposed on the screen.

FIG. 7.0 shows a tolerance volume as is.

FIG. 7.1 shows the initialization phase, in which the points s of the sampling S of the borders of the boundary region of the tolerance volume are apparent. On the outer border, for the label F(s)=1, these points are hollow circles. On the inner border, for the label F(s)=−1, they are solid circles.

FIG. 7.2 shows an envelope referred to as a ‘Loose Bounding Box’ or LBB. This loose bounding box (LBB) can be constructed by calculating the strict bounding box of the tolerance volume by means of the minimum and of the maximum of the x,y,z coordinates of the points of the tolerance volume. This box LBB is enlarged by a homothety with scale factor 1.5, for example.

The loose bounding box LBB comprises the points LBB1 to LBB4 which can be seen in FIG. 7.2. In 2D, the bounding box is formed by only 4 points, as opposed to 8 points in 3D. Others means may be used that allow external points to be defined whose bounding property is guaranteed.

Another set Sp of points sₚ is then considered. Initially empty, this set Sp firstly receives all the points of the loose bounding box LBB.

At the step 2015 in FIG. 4, a triangulation T is first of all carried out using these first points of the LBB placed in Sp, but which are not points of S.

The straight line segments which form the limits of the mesh elements are illustrated with long and thin dashed lines in FIG. 7.

Special label values are given to the points of the LBB, which depend on their distance with respect to the boundary of the tolerance volume. These special label values may be greater than 1.

For example: the label value 1 is assigned to the outermost border of the tolerance volume, and the label ‘d+1’ to the vertices of the LBB, where d represents the normalized distance between an vertex of the LBB and the point of the outer boundary of the tolerance volume which is the closest to the vertex of the LBB. The normalization is a function of the thickness of the tolerance volume, which is determined at the value 2 (the difference between −1 and +1).

The classification calculation, and that of the error ε, are then performed for all the non-inserted points of the set S, to which are added the points of the loose bounding box which are in the set Sₚ.

The calculation is subject to an exception in the case where a point of the sample is localized within a mesh element where the function is homogeneous, in other words with identical label values at the vertices of the mesh element. In this case, if the function has the same sign as the label of the point of the sample, then it is well classified, and else poorly classified, without the error ε being used.

As already indicated, all the points s of the set S have been assigned a label value F(s). The interpolation function f is constructed, as previously, for each mesh element (triangle in 2D, tetrahedron in 3D): for a point x of the set Sₚ, present within a tetrahedral mesh element, an interpolation linear function f(x, M) is calculated, defined on the basis of the label values F(s) at the vertices of the tetrahedron mesh element M, and of the barycentric coordinates of the point x in question, with respect to the vertices of the mesh element. Each time the error quantity £ is calculated, which indicates whether the point x is well classified or not.

In FIG. 7.2, a well classified point is represented by a square. A poorly classified point is represented by a cross.

It can be observed that the function interpolated over the two triangles LLB1-LBB2-LBB3 and LLB1-LBB3-LBB4 here is homogeneous and positive at all points, since the vertices of the LBB all have a label ‘d+1’ which is very positive.

This is therefore in the framework of the aforementioned exception.

The hollow circles in FIG. 7.1 have a positive label +1. They therefore have the same sign as the function interpolated over the two triangles, and consequently are well classified. Accordingly, these hollow circles in FIG. 7.1 become squares in FIG. 7.2.

On the other hand, the full circles in FIG. 7.1 have a negative label −1. They are therefore of opposite sign to the function interpolated over the two triangles, and hence poorly classified. Accordingly, these full circles in FIG. 7.1 become crosses in FIG. 7.2.

Subsequently, the refinement per se commences (step 203 in FIG. 2, and frame 203 in FIG. 4).

At the step 2031 in FIG. 4, a first Steiner point SP1 is added into the triangulation. The point SP1 is added to the set Sₚ of points to be triangulated.

The point SP1 may be that whose error ε is maximum, as is furthermore indicated here.

In FIG. 7.3, this first Steiner point SP1 is by chance located close to the diagonal L1 of the envelope LBB. The label of SP1 is F(SP1)=−1.

The classification calculation, and that of the error ε, are then repeated for all the points of the set S, and for the added point SP1 (step 2032 in FIG. 4).

The two end points LBB1 and LBB3 of the diagonal L1 belong to the LBB. This determines a version “SP1” of the function f, calculated as indicated above, within the 4 triangular mesh elements LBB1-LBB2-SP1, LBB2-LBB3-SP1, LBB1-LBB4-SP1, LBB3-LBB4-SP1. f(SP1)=−1 is finally obtained, which classifies well the added point SP1.

An isosurface IS1 is then defined around the point SP1, where f=0. This isosurface is illustrated by a thick black line, almost a square, in FIG. 7.3.

Considering the triangle LBB1-LBB2-SP1: The interpolated function is equal to −1 on SP1, and a positive value greater than 1 on LBB1 and LBB2, for example 5. Along the edge SP1-LBB1 the function therefore varies linearly from −1 to 5, and the zero level of the interpolated function f is therefore located near to SP1, just above.

Considering now the triangle LBB3-LBB4-SP1: By symmetry, another zero level of the interpolated function f is located near to SP1, this time just below.

The two vertical segments of IS1 are explained in the same way, by considering the triangles LBB2-LBB3-SP1 and LBB1-LBB4-SP1.

The 2D analysis carried out hereinabove may be extrapolated to 3D in the following manner: In 3D, the interpolated function f is always piecewise linear, but varies in space hence there is additionally a depth; and the zeroset isosurface (or Zset) is no longer a segment within a triangle, but a planar polygon within a tetrahedron, namely a triangle or a quadrilateral.

It can be observed that, on the horizontal row of points contained at the center of IS1, the points are now well classified, and the crosses have become squares, with F(s)=1. In contrast, the points situated outside of IS1 have remained crosses, with F(s)=−1, therefore poorly classified.

It can be observed that the low part of the contour IS1 is half way between the horizontal row of points contained within IS1, and the row of crosses situated underneath.

The other elements of the contour IS1 depend on the version “SP1” of the function f, as was explained above.

The isovalue IS1 represents the zero level of the interpolated function, which is therefore positive on one side of IS1, and negative on the other side of IS1. The points of the sample are well classified when they are situated on the side of IS1 which corresponds to the sign of their label or label value.

Other information useful for constructing a Delaunay triangulation may be found in [Ref23]. This information is to be considered as incorporated into the present description.

It should be noted that, for points in a general position (in 2D, no more than 3 co-circular points, and in 3D no more than 4 co-spherical points), there exists a single Delaunay triangulation, which is therefore canonical. One property is, in 2D, that the circles circumscribed on the triangles do not contain any other point; similarly, in 3D, the spheres circumscribed on the tetrahedrons of the network (constituted by points of the sub-set Sp of S) are empty, and do not contain any point other than the vertices of the tetrahedron.

The Delaunay triangulation is finished when all the points of the set S are correctly classified (step 2033 in FIG. 4).

If this is not the case, the steps 2031 to 2033 in FIG. 4 are repeated, inserting a new Steiner point.

This is what is done with the point SP2 in FIG. 7.4, which is added to the set Sₚ of points to be triangulated.

The classification calculation, and that of the error ε, are then repeated for all the points of the set S, and for the added points SP1 and SP2 (step 2032 in FIG. 4). This results in a version called “SP2” of the function f.

The points where this version “SP2” of the function f is zero define a new isosurface IS2 which encompasses the points SP1 and SP2. On the segments CC20 and CC22 of the contour of the tolerance volume, the points remain poorly classified (crosses). In contrast, in the neighborhood of SP2, the segments CC21 and CC23 contained in IS2 now comprise well classified points.

Similarly, the L-shaped segment CC24 becomes well classified, in contrast to the segments aligned on it, but external to IS2.

Conversely, the L-shaped segments CC25 and CC26 become poorly classified, in contrast to the segments aligned on them, but external to IS2.

At the test step of 2033 in FIG. 4, certain points of the set S remain poorly classified.

The steps 2031 to 2033 in FIG. 4 are therefore repeated, inserting a new Steiner point SP3, as illustrated in FIG. 7.5.

The classification calculation, and that of the error ε, are then repeated for all the points of the set S, and for the added points SP1, SP2 and SP3 (step 2032 in FIG. 4). This results in a version “SP3” of the function f.

The points where this version “SP3” of the function f is zero define a new isosurface IS3, which encompasses the points SP1, SP2 and SP3.

As previously, it is observed that the points that are inside of IS3 do not have the same classification as the points situated on the same row as them, but outside of IS3. At the test step 2033 in FIG. 4, certain points of the set S remain poorly classified.

The steps 2031 to 2033 in FIG. 4 will be repeated several times, each time inserting a new Steiner point. This gives FIG. 7.6, where the Steiner points are large black dots, if their label value is negative, or else large hollow circles, if their label value is positive.

The isosurface obtained comes close to the general shape of the tolerance volume, but some poorly classified points still remain.

The steps 2031 to 2033 in FIG. 4 will again be repeated several times, each time inserting a new Steiner point. This results in FIG. 7.7, where the isosurface is entirely contained within the tolerance volume and there are no longer any crosses (poorly classified points).

At the test step 2033 in FIG. 4, the end of the refinement has now been reached.

The method therefore moves on to the simplification (or decimation) phase 207 in FIGS. 2 and 4.

The step 203 in FIGS. 2 and 4, which is referred to as “refinement”, has thus been described. One of the aims of this refinement is to get to a mesh without surface intersection, which corresponds to the topology of the tolerance volume. As indicated by the word “refinement”, the mesh is developed “from-coarse-to-fine” by means of the successively inserted points.

The mesh itself may be constructed using a Delaunay triangulation, whose data structures do not accept surface intersections. Other techniques may be used for constructing canonical triangulations that do not intersect. The applicant currently prefers a triangulation using the Delaunay property, with the proof of termination and the guarantee of topology that it allows.

As indicated, the selection of the inserted Steiner points may be made as a function of the error quantity ε. This may be carried out on the basis of the member in FIG. 6, which will now be described, in the 3D version.

At the step 601, for each tetrahedron of the triangulation T, a list of those sample points s of the set S that are contained within this tetrahedron is kept. Each point is accompanied by its label, and by its error ε. The points of the set Sₚ which are already included in the triangulation are not in this list.

At the step 603, a dynamic priority queue is maintained, for each tetrahedron of the triangulation T, containing the maximum error points in the tetrahedrons, sorted by decreasing error.

At the step 605, which corresponds to the step 2031 in FIG. 4, the maximum error point at the head of the queue is added into the triangulation T, which point can then be eliminated from the queue.

At the step 607, which corresponds to the step 2032 in FIG. 4, the error calculations are updated. A test 609, which corresponds to the step 2033 in FIG. 4, examines whether the topology is correct, i.e. whether the set S is entirely classified. If this is not the case, the method returns to 601. Otherwise, it goes to the next phase for simplification of the mesh.

At the end of the refinement, the meshed representation in FIGS. 7.6 and 7.7 is correct, in the sense notably that it does not comprise any intersections and that it is isotopic. On the other hand, it is too dense and contains an excessive number of mesh elements (or of vertices). It will therefore be simplified, as will be seen hereinbelow.

FIG. 7.8 will firstly be considered.

The meshing by triangulation, which constitutes the refinement, results in a set of tetrahedrons. The union of the tetrahedrons, which constitute a meshed (triangulated) approximation of the tolerance volume Ω, is known as the “simplicial tolerance”, denoted Γ. These tetrahedrons have vertices with different labels.

The boundary of this “simplicial tolerance” is denoted ∂Γ (in FIG. 7.8). In 3D, this boundary is composed of triangles which are the free faces of the tetrahedrons of the mesh. This is a triangulated representation of the border of the region of tolerance. The dotted-dashed line in FIG. 7.8 illustrates those edges of this triangulated representation which are in the plane of the figure.

Accordingly, the simplification of the meshed representation in FIG. 7.7 or 7.8 may essentially be carried out using a process known as “edge collapse”.

The nature of this process will now be described with reference to FIG. 16, which are in 2D.

FIG. 16.0 indicates the ends A and B of one edge that may be collapsed (the conditions of which will be seen hereinbelow).

The general collapsing operator eliminates the edge joining the vertices, at least one of these two vertices, and the faces or tetrahedrons adjacent to the eliminated edge (FIG. 16.2). The position of the vertex P resulting from the collapse (target vertex) is one degree of freedom (continuous) of this operator, under the condition of preserving the topology and of correctly classifying all the points.

In the case where these two constraints (topology and classification) can be satisfied, there exist one or more regions of space (region of validity) where the target vertex P may be placed. It may be placed arbitrarily within this region, but it is preferable to choose an optimum point.

For this purpose, a error calculation at one point may be used. The error is for example the sum of the squares of the distances of this point to the planes containing the facets of the isosurface Z, these facets being selected in a neighborhood local to the edge in question. The local neighborhood may comprise the facets of the isosurface that are localized at a distance 2 from the edge in the graph of the triangulation (which is referred to as “2-ring”). The optimum point Q which minimizes this error is sought.

The error calculation is used as an optimization criterion. Indeed, as preferred point P, the point situated within the region of validity may then be taken, and which is located the closest possible to the optimum point Q which minimizes said error.

It should be noted that this mode for error calculation and for determining the preferred point P is particularly relevant for piecewise planar surfaces; other solutions may however be imagined depending on the nature of the input surfaces. For example, for piecewise curved surfaces, it may be imagined to choose parametric surfaces of the quadratic or cubic type rather than planes, and to take as error the sum of the squares of the distances to these surfaces.

In practice, in order to increase the speed of the processing, it is advantageous to also use, as a variant, a purely combinatorial operator that is referred to as “half-edge collapsing operator”: in this less general variant, the operator is constrained to merge one vertex of the edge onto the other. In FIG. 16.1, the vertex A is thus merged onto the vertex B. and the optimization criterion is defined by the distance between the target point (here the point B) and the optimum point Q calculated as hereinabove.

This half-edge collapsing operator is less powerful than the edge collapsing operator which allows the vertex resulting from the collapse to be placed at a general position P in space, but it is much faster to simulate, since the target point B is directly known, without having to look for the best point P.

The half-edge collapsing operator is said to be combinatorial in the sense that there exists a finite number of degrees of freedom: 2 E possible collapsing operations, where E represents the number of edges of the triangulation. Subsequently, when no half-edge collapsing is possible, the more general edge collapsing operator has to be employed.

It is important to understand the difference between the two phases: refinement and simplification.

During the refinement, points of the sample are inserted into a canonical triangulation (whose connectivity is determined by the positions of the points). Therefore, in this refinement phase, the degrees of freedom are only in terms of choice of points.

During the simplification, it will be seen that the collapsing operators act via edges or half-edges; therefore, a priority queue sorts the operators that are valid (which preserve the topology and classification of the points) according to a score which depends on an optimization criterion.

The final goal is to simplify as much as possible, and it is observed that certain positions of points after collapsing are conducive to a greater simplification, intuitively by better preparing the future simplifications because more collapsing operators will be valid as a consequence.

The constraints (topology and classification) will now be indicated which will allow it to be determined whether a collapsing operator in the process of simulation is applicable (“valid”) or not.

For the constraint on preservation of the topology, three notions may be used:
A “link condition”, described in [Ref21], for the D-manifold property. In 2D, this condition ensures that any neighborhood of a point is homeomorphic (topologically equivalent) to a disk or to a semi-disk. From a topological perspective, this condition imposes that each edge is adjacent to exactly one or two triangular faces, and that each vertex is adjacent to a single connected component. In 3D, this condition ensures that any neighborhood of a point is homeomorphic (topologically equivalent) to a sphere or a hemisphere.
The determination of a core of polyhedrons in order to verify that the embedding is valid [Ref27]. In 3D, the core of a polyhedron is the location of the points that see the entire border of the polyhedron. In the general case, the core is either empty or a convex polyhedron. The polyhedron considered for the calculation of the core is the polyhedron formed by the union of the tetrahedrons adjacent to the two vertices of the edge. When the core is not empty, the edge may be collapsed by placing the target vertex within the core: the triangulation remains valid, in other words with no overlap or reversal of tetrahedrons. When the core is empty, the edge cannot be collapsed without creating an invalid triangulation. In the present context, the construction of the core is used for bounding a search region for points which classify well (this is the point hereinafter).
The preservation of the classification of the points of the sample, which is done as previously, and that will be revisited hereinafter.

A collapsing operator in the process of simulation will therefore be considered as valid if:
The “link condition” is verified,
The valid embedding condition is verified,
The classification of the points of the sample is preserved.

The simplification process may correspond to FIG. 17.

All the edges existing in various parts of the triangulation will be considered one by one, beginning with the boundary of the simplicial tolerance, as will be seen.

For each edge, the step 1701 firstly simulates the collapsing of this edge, in order to determine whether this collapsing is possible (“valid”). As already indicated, a half-edge collapsing operator will firstly be tried, then a general edge collapsing operator. The simulation is carried out on the basis of the current state of the triangulation.

If the collapsing operator in the process of simulation is valid, the step 1703 stores its the definition in a dynamic priority queue. The order of priority is defined by the aforementioned optimization criterion.

At the step 1705, the first collapsing operator is applied, in the order of the priority queue.

After this, the step 1707 updates the priority queue:
Elimination of the operators that no longer have a reason for being, since they relate to an edge eliminated by the collapsing operator which has just been executed.
Re-simulation of the modified operators, which are put back in the queue, with their optimization criterion recalculated. An operator is “modified” when the collapsing operator which has just been executed has modified the parts of the triangulation which are adjacent to at least one of the two vertices of the edge to which it relates (or to both vertices).

The sub-steps 2072 to 2076 of the step 207 in FIG. 4 show that the operation takes place in three stages. In each stage, half-edge collapsing operations will firstly be considered, then general edge collapsing operations.

Here, a reciprocal triangulation (described in detail hereinbelow) is carried out in the step 2074, within the simplification phase. It would be conceivable to perform this reciprocal triangulation just after having performed the refinement. In other words, it may be envisioned for all the possible edges to be simplified after having carried out the entire refinement, including the reciprocal triangulation. The method provided is considered as more parsimonious because it enables a reduced complexity for the triangulation.

Thus, the applicant currently thinks that it is preferable to simplify the triangulation of the tolerance volume (the simplicial tolerance) prior to starting the reciprocal triangulation, then the rest of the simplification. The idea is to reduce the size of the triangulation before simplifying it since the number of operators to be used depends on this size.

The following point should also be noted: in the refinement, the 3D triangulation provided is a Delaunay triangulation; this is suitable as it is canonical for a set of points and the termination of the refinement can be proved. However, it is “verbose”: because it uses fixed points for the most isotropic possible triangulation—in other words not very parsimonious (in points) at the locations where the geometry is anisotropic. The idea is therefore to reduce the size of the triangulation prior to simplifying it because the number of operators to be used is a function of this size.

The simplification will be now illustrated, with reference to FIGS. 8.0 to 8.11.

FIG. 8.0 shows the mesh, in its state in FIG. 7.7, for which FIG. 7.8 has shown that this was the simplicial tolerance Γ. It is known that the isosurface Zset is contained within this “simplicial tolerance” volume denoted Γ.

The simplification is firstly applied to the boundary ∂Γ of the “simplicial tolerance” (step 2072 in FIG. 4).

In FIG. 8.0, two of the points are connected by an edge SF1, illustrated in bold, in order to indicate that they may be merged.

As already indicated, the merging of two adjacent vertices makes the edge joining them disappear, one of these two vertices, and the faces or tetrahedrons adjacent to the eliminated edge.

When two vertices are merged in 3D, two edges situated between these two points and a third (which is not in the plane of the figure) will also be merged (one collapsed onto the other).

As a consequence, all of the primitive elements (triangles in 2D or tetrahedrons in 3D) need to be considered which are adjacent to the vertices of the eliminated edge. The points of the sample which are situated within these primitive elements are here referred to as “points concerned by the collapsing”.

In the neighborhood of the edges to be collapsed, the error ε on all the points concerned by the collapsing must then verify the aforementioned condition:

ε<=(1−α)

In other words, all the points concerned by the collapsing are well classified (symbolized by squares) after the collapsing. This is what is referred to as preserving the classification condition for the points of the set S.

As indicated, it is determined in advance which are the collapsing operators that preserve the classification and the topology by “simulating” it, without applying it. Only the collapsing operators retained as suitable (“valid”) after simulation are placed in the dynamic priority queue of the step 1703.

With the aim of accelerating the processing operations, the half-edge collapsing operations are firstly carried out (half-edge collapse), whose operators are much faster to simulate. Subsequently, when no half-edge collapse is possible, the more general edge collapse operators are considered.

It may also be said that the Delaunay mesh elements in question must be homogeneous as far as the correct classification of the points is concerned. It should be noted that, for the simplification, it is not verified that the mesh continues to satisfy the Delaunay conditions.

The result after this first collapsing of half-edges and/or of edges is illustrated in FIG. 8.1.

The classification calculation, and that of the error ε, has been redone for those points of the set S which are concerned by the collapse. The isosurface has also been recalculated.

In FIG. 8.2, two of the points are connected by an edge SF2, illustrated in bold, in order to indicate they may also be collapsed.

The result after this other collapse is illustrated in FIG. 8.3.

This is repeated with all the points that can be collapsed. When there are no more edges to be collapsed (or points that can be merged) on the boundary of the simplicial tolerance ∂Γ, the result in FIG. 8.4 is obtained.

In summary, up to now, the simplification has comprised the following steps:
h1. Define a volume called “simplicial tolerance”, denoted Γ. It is constituted from a union of mesh elements from the Delaunay 3D triangulation, chosen so as to form a meshed approximation of the tolerance volume. This is illustrated in 2D in FIG. 7.8, where the dotted-dashed line indicates the boundary ∂Γ of this simplicial tolerance.
h2. Perform edge collapsing operations in ∂Γ, while verifying the preservation of the classification condition for S (FIGS. 8.1 to 8.4).

The process continues as follows:
h3. Carry out a mutual triangulation between the isosurface (Zset) and the volume called “simplicial tolerance”, such as modified in the operation h2 (step 2074 in FIG. 4).
   This mutual triangulation (sometimes called reciprocal triangulation) adds vertices with the value F(v)=0 (where v denotes an vertex), edges and mesh elements into the 3D triangulation, onto the isosurface.

Through this mutual triangulation operation in the step h3, the isosurface Z will, in a manner of speaking, be integrated into the general triangulation of the “simplicial tolerance” volume, denoted Γ.

In 2D, the mutual triangulation between a triangulation 2D T and a polygonal line L (whose vertices coincide with the edges of the triangulation) consists in inserting all the vertices of L into T, all the edges of L into T, then conforming the triangulation by adding edges to T so as to only obtain triangles.

The mutual triangulation operation is illustrated in FIG. 15, on an object resembling that in FIG. 3:

The operation starts (FIG. 15.1) with an existing triangulation (at the point up to where it is rendered) indicated with dashed lines, and the isosurface Zset indicated with thick black lines.

FIG. 15.2 illustrates the reciprocal triangulation of the curve Zset and of the existing triangulation: new vertices appear (black dots) on the line Zset, new edges, and new triangles. The curve Zset is now represented in the form of a chain of edges of the triangulation.
Finally, in FIG. 15.3, the triangles are classified according to the sign of the interpolated function (white=positive, gray=negative).

For the example in FIG. 8, the result is illustrated in FIG. 8.5. Edges added to the triangulation (dashed lines) and new vertices (black dots) can be seen.
h4. Perform edge collapsing operations on this isosurface Z, which adopts its definitive configuration after these simplifications. (FIGS. 8.6 to 8.8).
h5. Continue with edge collapsing operations, on all the possible edges in the “simplicial tolerance” volume, while notably verifying the preservation of the classification condition of the set S of sample points (step 2076 in FIG. 4).

The process continues, for as long as there remain edges to be collapsed, on the inside of Z. It stops when no edge can be collapsed without violating the conditions of classifications of the points and of topology.

In the above description, the simplification uses edge collapsing operators as triangulation modification operators. It is conceivable to use other triangulation modification operators, at least in part, for example:
continuous operators (displacement of vertices),
combinatorial operators, which, aside from the aforementioned “half-edge” collapsing, comprise operators such as those referred to as “4-4 flips”, or else “edge-removal”, as can be seen in FIG. 1 from
http://graphics.berkeley.edu/papers/Klingner-ATM-2007-10/Klingner-ATM-2007-10.pdf
and the mixed operators whose general edge collapsing is one example.

Combinations of operators may also be used (for example general edge collapsing, followed by a 4-4 flip, then by an edge-removal).

The embodiment described avoids excessive requirements in terms of memory and processing complexity. Its final result is illustrated in FIG. 8.10. FIG. 8.11 is similar to FIG. 8.10, but with the symbols illustrating the classification of the points removed.

In the final contour in FIG. 8.11, the isosurface Zset fits exactly inside of the tolerance volume.

In the end, the isosurface Zset forms a meshed surface approximation of the tolerance volume. It may be considered that Zset and ∂Γ have merged during the mutual triangulation.

The member which has just been described (refinement+simplification) works well in the general case. It may need to be adjusted in certain specific situations.

Certain factors could compromise the phase for refinement of the topology.

First of all, it is possible for the isosurface Zset to pass through ∂Γ between two samples, for example owing to the presence of a flat tetrahedron (“sliver”).

This is at least in part avoided by using the aforementioned parameter α in the classification. It has been seen that a point s is considered as well classified if

ε(s)<=(1−α)

The heterogeneous tetrahedrons are then considered, which are those whose vertices have different label values F(s). A quantity or “height” h is also considered, which is the distance between the triangles with maximum dimensions, formed by the vertices of the tetrahedron which have the same label value.

In FIG. 9A, the three vertices B, C and D have the same label, and h is the minimum distance between the vertex A and the plane containing the face BCD.

In FIG. 9B, the vertices A and B have the same label. Similarly, the vertices C and D have the same label. h is the minimum distance between the straight line through AB and the straight line through CD.

Furthermore, these heterogeneous tetrahedrons are constrained such that h>=2/(σα).

This is a way of making sure that the interpolation function f verifies the Lipschitz criterion, according to which the absolute value of the gradient of this function f is bounded.

A suitable choice for a thus means the problems of flat tetrahedrons (“sliver”) are naturally resolved.

Others factors affecting the refinement which can be encountered also include problems of orientation (direction of the perpendiculars or “normals”) in complex regions.

These may be solved using the preceding technique. Preferably, and optionally, it will also be verified, for each tetrahedron, that an extension of the piecewise linear function, outside of the tetrahedron, also correctly classifies points of the sample not only within the tetrahedron, but also outside. It will then be said that the interpolation function f classifies the “local geometry”.

The value to be chosen for a depends on the nature of the input data. The value α=0.2 is a good choice, at least as starting value.

Reference is now made to FIG. 10, which illustrate, in the upper part, raw representations of an elephant (from left to right: a point cloud without noise, a triangle soup without noise, a point cloud with noise, and a triangle soup with noise), and in the lower part, the triangulation obtained according to the invention. For each example, the raw data are converted into a tolerance volume by calculating a sub-level of the ‘distance to the data’ function (points or triangles).

On the left (FIG. 10 A), the starting image is a cloud of points which do not have any significant effect on the final triangulated surface. Further to the right (FIG. 10 B), the starting data forms an unorganized soup of triangles (with intersections, holes) which do not have any significant effect either on the quality of the final triangulated surface. Even further to the right (FIG. 10 C), the starting data is a cloud of points with a high level of noise (uncertainty on their coordinates) which does not have any significant effect either on the quality of the final triangulated surface. Finally, over on the right (FIG. 10 D), the starting data forms a very irregular and noisy triangle soup which does not have any significant effect either on the quality of the final triangulated surface. It is simply noted that the triangulation is less detailed in FIG. 10 C and 10 D, in the case where the starting data have a high level of noise, and for which a larger tolerance volume is chosen.

These examples illustrate well the robustness of the technique according to the invention.

The invention has been developed using the following data processing suite:
INTEL machine: Intel 2.4 GHz with 16 cores and 128 Gigabytes of RAM,
For the triangulation data structures: CGAL library, available from the company Geometry Factory, 20, Avenue Yves Emmanuel Baudoin, 06130 Grasse, France,
INTEL library: “Threading Building Blocks library” for parallelization. It is observed that the “atomic” processing operations on the tetrahedrons and the sample points are independent and can therefore easily be run in parallel.

FIG. 11 again show the component from FIG. 1. FIG. 11.0 is the tolerance volume. FIGS. 11.1 to 11.4 illustrate the final mesh obtained, with different processing conditions, as regards the factor δ, expressed as a percentage, which is the distance of separation between the borders of the tolerance volume. The following table indicates the values of δ, the processing time with the equipment indicated hereinabove, the figure with the final mesh, and the number of vertices of the latter.

| Value δ | | | |
|---|---|---|---|
| (%) | Total processing time | Final mesh | Final number of vertices |
| 1.5 | 34 mn | FIG. 11.4 | 254 |
| 0.9 | | FIG. 11.3 | 493 |
| 0.35 | | FIG. 11.2 | 1015 |
| 0.15 | Around 7 hours | FIG. 11.1 | 3020 |

It can be seen that the processing time decreases as the tolerance increases. Generally speaking, the process is slow, which is the ‘quid pro quo’ for its robustness.

The performance achieved by the invention is illustrated in FIG. 12.

It will be observed that a strict comparison with the prior art is not possible since the constraints of the problem posed here are different.

The invention may however be compared with the following methods provided elsewhere:
Lindstrom-Turk, which is the method described in [Ref19], and which can be implemented by means of the CGAL library version 4.6, marketed by the company Geometry Factory, already mentioned,
MMGS, which is the method described in [Ref7], implemented by a software application MMGS version 2.0a, transmitted directly by Pascal Frey, second author of [Ref7],
MMGS-A, which is a variant of the same MMGS application with the mesh anisotropy option,
Open Flipper, which is the method described in [Ref20], with a software application available by downloading from the website www.openflipper.org/, version 2.1.
Simplification Envelopes, which is [Ref9], with a software version 1.2, transmitted by email by the first author.

The Haussdorf distance measures the dissemblance between two geometrical shapes. The unidirectional distance Haussdorf(A,B) is defined by the maximum of the Euclidian distance between the shape A and the shape B, for any point of A, and vice versa for Haussdorf(B,A). The symmetrical variant is the maximum of Haussdorf(A,B) and Haussdorf(B,A).

The scale of the ordinate axis in FIG. 12 corresponds to the Hausdorff distance H_{|O->|}, which is the unidirectional Hausdorff distance between the output and the input. The scale of the abscissa axis corresponds to the number of vertices at the output.

This FIG. 12 shows that the invention is better than the other techniques by shorter Haussdorf distances, with lower final numbers of vertices, in addition to the robustness already shown hereinabove.

FIGS. 12 and 13 have as input a raw surface mesh of the images in FIG. 14 (around 14,000 vertices).

FIG. 13 relates to the processing time. It illustrates the variation of the complexity of the mesh as a function of the processing and of time for various values of the input tolerance δ, indicated in the legend rectangle. On the abscissa axis are the various steps of the processing, namely:
Refinement,
Simplification by collapsing operations on half-edges of the border ∂Γ of the simplicial tolerance,
Simplification by collapsing operations on edges of the border ∂Γ of the simplicial tolerance,
Mutual triangulation and collapsing operations on half-edges of the zeroSet Z,
Collapsing operations on edges of the zeroSet Z,
Simplification of all the boundaries.

The invention also allows surfaces having holes to be processed, for example when they are obtained by laser scanning which is tangent to concave regions. The holes may be eliminated as long as the tolerance volume encompasses them.

The invention may also be defined as a device.

FIG. 18 again shows the elements in FIG. 4, whose steps are carried out by operators. In the numerical references, the most significant digit is 2 for the steps and 3 for the operators.

Thus, the initialization step 201 in FIG. 4 is carried out by the initialization operator 301 in FIG. 18. It starts from the tolerance volume, stored in 310. Inside of this initialization, the step 2011 in FIG. 4 is performed by the contour sampling operator 3011 in FIG. 18.

FIG. 19 illustrates a point classification operator, referenced 1900.

For a point to be classified, the operation starts from the following data (at least in part, some data being deductible from the others):
the coordinates of this point,
the label of this point,
the mesh element surrounding this point, with the coordinates and labels of the vertices of this mesh element.

An operator 1901 calculates the interpolation function f, as described above with reference to FIG. 5. It supplies a label calculated for this point. The operator 1902 deduce from this whether the point is well classified or not, as already described.

It will be observed that this FIG. 19 does not reflect the exceptional cases, such as that where all the vertices of the mesh element have the same label value.

This point classification operator, 1900, is called numerous times, notably by the operators 3013 and 3032 in FIG. 18, but also by the simulation operator 1701 in FIG. 17, given that the latter has to verify that the classification of the points is preserved.

### APPENDIX 1—DEFINITIONS

### Isomorphism

In mathematics, an isomorphism between two structured sets is a bijective application which preserves the structure and whose inverse function also preserves the structure (for many structures in algebra, this second condition is automatically fulfilled; but this is not the case in topology for example where a bijection may be continuous, while its inverse function is not).

### Homomorphism

In topology, a homomorphism is a continuous application, from one topological space into another, whose inverse function is also a continuous bijection. In view of the above, it is accordingly an isomorphism between two topological spaces.

When it is stated that two topological spaces are homomorphic, this means that they are “the same”, seen differently. This is not always immediately obvious. It is demonstrated for example that a cup (with a handle) is homeomorphic to a torus, since there exists a transformation going from one to the other: fill the body of the cup with material, then deform it progressively, with its handle, so that the whole forms a torus. The reciprocal transformation returns to the cup.

### Isotopy

The notion of isotopy is notably important in the knot theory: two knots are considered identical if they are isotopic, in other words if one may be deformed in order to obtain the other without the “string” ripping apart or penetrating itself.

This notion of isotopy should not be confused with the isotopy in chemistry, nor with isotropy in the materials physics.

### Tolerance Volume

This is applicable to a three-dimensional component. The tolerance volume for a component is the volume included between its largest and smallest admissible external surface.

In practice, there may be several connected components of the tolerance volume. There may also be several connected components of its boundary surfaces, even if the tolerance volume itself only has a single connected component.

### APPENDIX 2—REFERENCES

[Ref1]. AGARWAL, P. K., AND SURI, S. 1998. Surface approximation and geometric partitions. Journal of Computing 27, 4, 1016-1035.
[Ref2]. AMENTA, N., AND BERN, M. 1998. Surface reconstruction by voronoi filtering. Discrete and Computational Geometry 22, 481-504.
[Ref3]. AMENTA, N., CHOI, S., DEY, T. K., AND LEEKHA, N. 2000. A simple algorithm for homeomorphic surface reconstruction. In Proceedings of ACM Symposium on Computational Geometry, 213-222.
[Ref4]. BISCHOFF, S., PAVIC, D., AND KOBBELT, L. 2005. Automatic restoration of polygon models. ACM Transactions on Graphics 24, 1332-1352.
[Ref5]. BOISSONNAT, J.-D., AND CAZALS, F. 2000. Smooth surface reconstruction via natural neighbour interpolation of distance functions. In Proceedings of ACM Symposium on Computational Geometry, 223-232.
[Ref6]. BOISSONNAT, J.-D., AND OUDOT, S. 2005. Provably good sampling and meshing of surfaces. Graphical Models 67, 5, 405-451.
[Ref7]. BOROUCHAKI, H., AND FREY, P. 2005. Simplification of surface mesh using hausdorff envelope. Computer Methods in Applied Mechanics and Engineering 194, 48-49, 4864-4884.
[Ref8]. CHAZAL, F., AND COHEN-STEINER, D. 2004. A condition for isotopic approximation. In Proceedings of ACM Symposium on Solid Modeling and Applications, 93-99.
[Ref9]. COHEN, J., VARSHNEY, A., MANOCHA, D., TURK, G., WEBER, H., AGARWAL, P., BROOKS, F., AND WRIGHT, W. 1996. Simplification envelopes. In Proceedings of ACM Conference on Computer Graphics and Interactive Techniques, 119-128.
[Ref10]. COHEN, J., MANOCHA, D., AND OLANO, M. 2003. Successive mappings: An approach to polygonal mesh simplification with guaranteed error bounds. International Journal of Computational Geometry and Applications 13, 1, 61-96.
[Ref11]. DEY, T. K., AND GOSWAMI, S. 2003. Tight cocone: A watertight surface reconstructor. In Proceedings of ACM Symposium on Solid Modeling and Applications, 127-134.
[Ref12]. DEY, T. K., AND SUN, J. 2005. An adaptive mls surface for reconstruction with guarantees. In Proceedings of EUROGRAPHICS Symposium on Geometry Processing.
[Ref13]. DEY, T. K., LI, K., RAMOS, E. A., AND WENGER, R. 2009. Isotopic reconstruction of surfaces with boundaries. Computer Graphics Forum 28, 5, 1371-1382.
[Ref14]. DEY, T. K. 2006. Curve and Surface Reconstruction: Algorithms with Mathematical Analysis (Cambridge Monographs on Applied and Computational Mathematics). Cambridge University Press.
[Ref15]. GUEZIEC, A. 1996. Surface simplification inside a tolerance volume. Tech. Rep. 20440. IBM Research Report RC 20440.
[Ref16]. HORNUNG, A., AND KOBBELT, L. 2006. Robust reconstruction of watertight 3d models from non-uniformly sampled point clouds without normal information. In Proceedings of EUROGRAPHICS Symposium on Geometry Processing, 41-50.
[Ref17]. JU, T. 2004. Robust repair of polygonal models. ACM Transactions on Graphics 23, 3, 888-895.
[Ref18]. KALVIN, A. D., AND TAYLOR, R. H. 1996. Superfaces: Polygonal mesh simplification with bounded error. IEEE Computer Graphics and Applications 16, 3.
[Ref19]. LINDSTROM, P., AND TURK, G. 1999. Evaluation of memoryless simplification. IEEE Transactions on Visualization and Computer Graphics 5, 2, 98-115.
[Ref20]. MOBIUS, J., AND KOBBELT, L. 2012. Openflipper: An open source geometry processing and rendering framework. In Proceedings of International Conference on Curves and Surfaces, Springer-Verlag, 488-500.
[Ref21]. Tamal K. Dey, Anil N. Hirani, Bala Krishnamoorthy, Gavin Smith. Edge Contractions and Simplicial Homology. arXiv:1304.0664.
[Ref22]. AGGARWAL, A., BOOTH, H., O'ROURKE, J., SURI, S., AND YAP, C. K. 1985. Finding minimal convex nested polygons. In Proceedings of ACM Symposium on Computational Geometry, 296-304.
[Ref23]. BOISSONNAT, J.-D., AND YVINEC, M. 1998. Algorithmic Geometry. Cambridge University Press.
[Ref24]. CIAMPALINI, A., CIGNONI, P., MONTANI, C., AND SCOPIGNO, R. 1997. Multiresolution decimation based on global error. The Visual Computer 13.
[Ref25]. COXETER, H. S. M. 1969. Introduction to geometry (2nd ed.). John Wiley and Sons.
[Ref26]. GUMHOLD, S., BORODIN, P., AND KLEIN, R. 2003. Intersection free simplification. International Journal of Shape Modeling 9, 2.
[Ref27]. Lee, D. T.; Preparata, F. P. (1979), “An Optimal Algorithm for Finding the Kernel of a Polygon”, Journal of the ACM 26 (3): 415-421, doi:10.1145/322139.322142.
[Ref28]. ZELINKA, S., AND GARLAND, M. 2002. Permission grids: Practical, error-bounded simplification. ACM Transactions on Graphics 21, 2, 207-229.

1. A method for processing geometric data, comprising the following steps:
A. receive a tolerance volume Ω, relating to raw geometric starting data,
B. initiate a canonical triangulation within the tolerance volume, using a set S of sample points taken from the limits of this tolerance volume, and of points situated outside of the latter,
C. refine this canonical triangulation, until the points of the sample are classified, thereby providing a dense mesh for the tolerance volume, and
D. simplify this dense mesh by triangulation modification operations, while preserving the topology and the classification of the points of the sample.

2. The method as claimed in claim 1, characterized in that the step B comprises the sub-step for sampling the limits of the tolerance volume according to a chosen sampling density σ, which supplies the set S of sample points.

3. The method as claimed in claim 2, characterized in that the step B comprises the marking of each sample point of the set S with a label value which represents the index of the boundary connected component of this point, within the tolerance volume, and
in that the step C comprises the iterative generation of the canonical triangulation, by inserting one point at a time, on at least a part of the set S of points, until all the points concerned verify a classification condition based on the value of a function F, itself depending on their index value, and on its interpolation by an interpolation function f applied to each mesh element of the 3D triangulation, and
the construction of a piecewise linear isosurface Zset, by using the points where the interpolation function f has the same chosen intermediate value, in particular zero, this isosurface Zset being a closed surface, which forms a surface approximation of the tolerance volume.

4. The method as claimed in claim 1, characterized in that the canonical triangulation is a Delaunay triangulation.

5. The method as claimed in claim 1, characterized in that the raw geometric starting data is 3D data.

6. A method for processing geometric data as claimed in claim 1, characterized in that the step D comprises the following operations:
D1. determine whether triangulation modification operations are valid, in other words preserve the topology of the mesh and preserve the classification condition of the set S of sample points, and
D2. carry out the valid triangulation modification operations in a given order.

7. The method as claimed in claim 6, characterized in that the triangulation modification operations comprise collapsing of edges and/or collapsing of half-edges.

8. The method as claimed in claim 6, characterized in that the order is determined according to an optimization criterion.

9. The method as claimed in claim 6, characterized in that the step D relates to a volume referred to as “simplicial tolerance” which approximates the tolerance volume by a union of meshes of the canonical triangulation, the isosurface Zset being contained within this volume called “simplicial tolerance”,
and in that the steps D1 and D2 are carried out:
firstly, on the boundary of the volume called “simplicial tolerance”,
subsequently, on the product of a mutual triangulation between the isosurface (Zset) and the volume called “simplicial tolerance”, this mutual triangulation adding vertices, edges and meshes into the triangulation, on the isosurface,
lastly, with other edges contained within the volume called “simplicial tolerance”, until all the possible edges are covered.

10. A device for processing geometric data, comprising:
a memory for geometrical data, for receiving data representing a tolerance volume,
an initialization member, arranged for carrying out a first canonical triangulation between the edge of the tolerance volume and points situated outside of the latter,
a refinement member, arranged for defining said first triangulation until a dense mesh is supplied for the tolerance volume, which preserves a classification condition for the points of the triangulation,
a simplification member, arranged for simplifying said dense mesh, while preserving the topology and the classification of its points, and
a pilot who successively activates the initialization member, the refinement member, and the simplification member, for graphical data that varies starting from the same tolerance volume.

11. The device as claimed in claim 10, characterized in that it comprises: a point classification operator, which receives the designation of a point to be processed and determines an interpolation function on the basis of the mesh element surrounding this point to be processed, and of label values relating to the vertices of this mesh element, so as to supply an interpolated label, and to compare the latter with a current label of the point to be processed, which allows the determination of a classification condition of the point to be processed.

12. A computer program product comprising portions of program code for implementing the method as claimed in claim 1, when the program is executed on a computer.
